(19) United States
(12) Patent Application Publication
(10) Pub. No.: US 2026/0175204 A1
(43) Pub. Date: Jun. 25, 2026

(54) BIOMASS CONVERSION TO BIO-JET OVER HETEROGENEOUS CATALYSTS

(71) Applicant: EXXONMOBIL TECHNOLOGY AND ENGINEERING COMPANY, Spring, TX (US)

(72) Inventors: Jihad M. DAKKA, Whitehouse Station, NJ (US); Christine N. ELIA, Bridgewater, NJ (US); Prateek MEHTA, San Francisco, CA (US); Xinrui YU, Furlong, PA (US); Mobae AFEWORKI, Phillipsburg, NJ (US); Michael P. LANCI, Flemington, NJ (US); Darryl D. LACY, Easton, PA (US); Patrick J. HILL, Long Valley, NJ (US); Yi DU, Coopersburg, PA (US); Brandon M. CARCUFFE, Hackettstown, NJ (US); Cynthia F. OMILIAN, Annandale, NJ (US)

(21) Appl. No.: 19/539,522

(22) Filed: Feb. 13, 2026

Related U.S. Application Data
(63) Continuation of application No. PCT/US2024/042429, filed on Aug. 15, 2024.
(60) Provisional application No. 63/520,195, filed on Aug. 17, 2023.

(51) Int. Cl. B01J 29/40; B01J 21/12; B01J 35/64

(52) U.S. Cl. CPC B01J 29/40; B01J 21/12; B01J 35/647; C10G 2300/202; C10G 2400/08

(57) ABSTRACT

A variety of methods are disclosed, including, in one embodiment, a method including: introducing a feed comprising an alcohol and an activator into a reactor comprising a solid acid catalyst; and contacting the alcohol and the activator in the presence of the solid acid catalyst under conditions effective to convert at least a portion of the alcohol and the activator to produce a product stream comprising C₆-C₁₆ olefins.

### CROSS-REFERENCE TO RELATED APPLICATIONS

This application is the U.S. National Phase of International Application No. PCT/US24/042429, filed Aug. 15, 2024, which designates the United States and claims priority to U.S. Provisional Patent Application No. 63/520,195, filed Aug. 17, 2023. The entire disclosures of the foregoing applications are hereby incorporated by reference in their entirety for all purposes.

### FIELD

This application relates to processes and systems for production of jet range hydrocarbons from alcohols in a single step process.

### BACKGROUND

Aviation is difficult to decarbonize due to the need for energy dense fuel sources. Conventional jet fuels are advantageous as they are readily produced from fractional distillation of crude oil, have high energy density, and are liquid across a broad range of temperatures and pressures. The hydrocarbons in jet fuel are typically mixtures of paraffin, naphthene, and aromatics with carbon numbers from 9 to 16 (C₉-C₁₆). Jet fuels are typically formulated with various ratios of isomers of the C₉-C₁₆ hydrocarbons to provide the desired cold pour properties, freezing point, density, autoignition temperature, and other physical properties.

Alcohols such as ethanol are readily produced from renewable resources. While there has been strong interest in the industry to produce a bio-jet fuel derived partially or entirely from renewable resources, commercially available solutions to convert alcohols to jet range hydrocarbons involve multiple steps with low selectivity to the desired jet range product. The first step of converting alcohols to bio-jet includes 5-7 fixed bed reactors for converting ethanol to ethylene, where the reactor temperature is typically above 350° C. The second step is dimerization of ethylene to butene over Ni catalyst. The butene is then further oligomerized over a heterogeneous catalyst to produce a range of C₆-C₄₀ molecules. The butene oligomerization step has low selectivity to jet range hydrocarbons and higher selectivity to cracking thereby reducing the yield of jet range hydrocarbons. Further, there is a need for multiple distillation processes to separate products to jet range hydrocarbons. There have been alternative routes proposed to directly convert ethanol jet range hydrocarbons, all of which have been unsuccessful. In these techniques at low temperatures, such as less than 250° C. the main product is diethyl ether. When the temperature is increased above 350° C. a product distribution of C₂-C₄₀ is obtained which includes a large fraction of cracked products.

### SUMMARY

Disclosed herein are example processes and systems for producing jet range hydrocarbons such as those with carbon numbers from C₈-C₁₆ and, more particularly, disclosed are methods for producing jet range hydrocarbons from alcohols, such as bio alcohols, using an activator and a solid acid catalyst.

Disclosed herein is an example method including: introducing a feed comprising an alcohol and an activator into a reactor comprising a solid acid catalyst; and contacting the alcohol and the activator with the solid acid catalyst under conditions effective to convert at least a portion of the alcohol and the activator to produce a product stream comprising C₆-C₁₆ olefins.

Further disclosed herein is an example method including: introducing a feed comprising ethanol and an activator comprising a C₃-C₁₆ alcohol and/or a C₃-C₁₆ olefin into a reactor; contacting the alcohol and the activator with a solid acid catalyst to produce at least C₈-C₁₆ olefins; and withdrawing a product stream from the reactor, the product stream comprising the C₈-C₁₆ olefins.

Further disclosed herein is an example composition including: at least 40 wt. % C₆-C₁₆ dibranched olefins; diethyl ether; water; and ethanol.

These and other features and attributes of the disclosed methods and compositions of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is an illustrative depiction of a block flow diagram of a process for producing jet range hydrocarbons, in accordance with certain embodiments of the present disclosure.

FIG. 2. is an illustrative depiction of a block flow diagram of a process for producing jet range hydrocarbons, in accordance with certain embodiments of the present disclosure.

FIG. 3. is an illustrative depiction of a block flow diagram of a process for producing jet range hydrocarbons, in accordance with certain embodiments of the present disclosure.

FIG. 4 is a graph of experimental results from converting ethanol to C₈+ products using iso-butanol as the activator, in accordance with certain embodiments of the present disclosure.

FIG. 5 is a graph of experimental results from converting ethanol to C₈+ products using iso-butanol as the activator, in accordance with certain embodiments of the present disclosure.

FIG. 6 is a bar graph of the conversion weight percent of experimental results from conversion of ethanol to C₈+ products, in accordance with certain embodiments of the present disclosure.

FIG. 7 is a bar graph of the selectivity weight percent of experimental results of conversion of ethanol to C₈+ products, in accordance with certain embodiments of the present disclosure.

FIG. 8 is a graph of experimental results testing catalyst time on stream and conversion of ethanol, in accordance with certain embodiments of the present disclosure.

FIG. 9 is a graph of experimental results testing catalyst time on stream and conversion of ethanol, in accordance with certain embodiments of the present disclosure.

FIG. 10 is a bar graph of experimental results testing catalyst time on stream and selectivity to C8+ products, in accordance with certain embodiments of the present disclosure.

FIG. 11 is a bar graph of experimental results showing conversion and selectivity of alcohol and activator co-fed with water, in accordance with certain embodiments of the present disclosure.

FIG. 12 is a bar graph of experimental results showing conversion of ethanol with a recycle stream, in accordance with certain embodiments of the present disclosure

### DETAILED DESCRIPTION

Disclosed herein are methods of producing jet range hydrocarbons such as those hydrocarbons with carbon numbers from C₆-C₁₆ and, more particularly, disclosed are methods for producing jet range hydrocarbons from alcohols, such as bio alcohols, using an activator and a solid acid catalyst. Advantageously, each feed component to the presently disclosed processes and methods may be sourced from biomass such that jet range hydrocarbons produced are entirely bioderived. In embodiments, a method may include introducing a feed comprising an alcohol and an activator into a reactor and contacting the alcohol and activator in the presence of a solid acid catalyst to produce C₆-C₁₆ olefins including C₆-C₁₆ branched chain olefins. In embodiments, the C₆-C₁₆ olefins are hydrogenated to saturate the olefins to produce a jet range hydrocarbon product which includes hydrocarbons with carbon numbers from C₆-C₁₆. In embodiments, the jet range hydrocarbons produced from alcohol and activator may be blended with other jet range hydrocarbons and/or additives to produce a jet fuel which meets a jet fuel specification such as ASTM D1655-22 including Jet A and Jet A-1.

It is believed that the solid acid catalyst facilitates several reactions to produce jet range hydrocarbons from the alcohol and activator feed. In embodiments where the alcohol is ethanol, a mechanism may include i.) dehydration of ethanol to a corresponding diethyl ether, ii.) dehydrating the activator to a corresponding activator olefin, and iii.) dimerization and oligomerization of the diethyl ether and activator olefin to produce jet range C₆-C₁₆ olefins. In embodiments, the activator feed comprises an olefin and step ii.) is not required to dehydrate the activator to form the olefin. The activator and solid acid catalyst function synergistically to initiate and sustain hydrocarbon chain growth to produce a variety of products, including C₆-C₁₆ olefins. It is further believed that the high activity of the solid acid catalyst and selectivity to C₈+ hydrocarbons arise in part from water from the dehydration reaction interacting with acid sites on the solid acid catalyst which moderates the acid strength to a level where dehydration and oligomerization reactions can occur. Dehydration reactions may be favored by a relatively weaker acid catalyst whereas oligomerization reactions may be favored by a relatively weaker and/or medium acid strength. It is further believed that the formation of a thin layer of water from the dehydration reaction on the catalyst surface facilities the diffusion of oxygenates to the acid sites and moderates the concentration of C₁₂-C₁₆ hydrocarbon species on the catalyst surface by preventing the diffusion of C₁₂-C₁₆ species back to the acid sites via competitive absorption. The competitive adsorption may moderate the reaction to produce the desired range of C₆-C₁₆ olefins while reducing undesired side reactions such as hydrogen transfer which can produce aldehydes and ketones by reaction of olefins with alcohol in the presence of water. Aldehydes can undergo further reactions which form higher carbon number oxygenates and coke if reactor conditions are favorable for coke production.

Reaction 1, Reaction 2, and Reaction 3 show a general overview of the process to produce a range of iC₆-iC₁₆ olefins and jet range hydrocarbons in accordance with some embodiments of the present application. In Reaction 1, an activator alcohol, represented as R₁—OH is dehydrated to produce the corresponding olefin and water. In Reaction 2, an alcohol, represented as R₂—OH is dehydrated to form the corresponding ether and water. In Reaction 3, the olefin produced in Reaction 1 and the ether produced in reaction 2 are oligomerized to form C₆-C₁₆ olefins. In reaction 4, the C₆-C₁₆ olefins are hydrogenated to produce the corresponding C₆-C₁₆ paraffins. In some embodiments, the activator is provided as an olefin and reaction 1 does not necessarily occur. Once the C₆-C₁₆ paraffins are produced they may be utilized as a blending stock to produce jet fuel that meets a jet fuel specification. In embodiments the C₆-C₁₆ paraffins include C₆-C₁₆ branched chain paraffins.

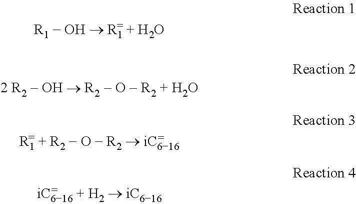

### Alcohol Feeds

In embodiments, alcohols suitable for the present process include alcohols with carbon numbers from C₁ to C₇ and isomers thereof. Some specific suitable alcohols include monohydric alcohols, diols, triols, and higher order alcohols. Without limitation, the alcohol may include methanol, ethanol, propanol, iso-propanol, butanol, iso-butanol, tert-butyl alcohol, pentanol and isomers thereof, hexanol and isomers thereof, heptanol and isomers thereof, and combinations thereof. Suitable alcohols may be obtained from any source. For example, the alcohol may be biologically derived, such as through fermentation of bio feedstocks to ethanol and other bio derived alcohols such as methanol and butanol, for example. Alcohols may also be sourced from separation from biological sources such as separation from carbohydrate fermentation. Alcohols may also be separated as a natural component from organisms such as butanol from Cichorium endivia and Paeonia lactiflora, pentanol from Angelica gigas and Paeonia lactiflora, hexanol from Picea abies and Citrus maxima, and heptanol from Achillea grandifolia and Opuntia ficus-indica, for example. Alcohols derived from such bio feedstock may additionally comprise impurities including members including, but not limited to, water, ethanol, xylose, furfural, lactic acid, 5-hydroxymethylfurfural (HMF), and combinations thereof. Water and/or organic fermentation impurities may be removed from the alcohol prior to processing to form jet range hydrocarbons. However, the solid acid catalyst of the present application may be tolerant to some level of impurities without affecting selectivity to jet range hydrocarbons and thus alcohol with some level of impurities is tolerable in the present process to maintain process simplicity. Alcohols used in the present process may also be sourced from petrochemical processes such as ethanol from the hydrolysis of ethylene.

### Activator Feeds

In embodiments, activators suitable for the present process include those which promote the oligomerization reactions to produce jet range hydrocarbons from the alcohol. Without being limited by theory, it is hypothesized that the activator acts as an electron donor in the oligomerization reaction allowing the oligomerization reaction to support molecular weight growth produce the C₆-C₁₆ olefins including C₆-C₁₆ branched chain olefins. The activator enhances the conversion of alcohol to jet range hydrocarbons and is consumed in the process as a cofeed. The activator can also directly react with itself to grow molecular weight. In embodiments, suitable activators can include linear and/or branched C₃+ alcohols and/or linear and/or branched C₃+ olefins. In embodiments, the activators include linear and/or branched C₃-C₁₆ alcohols and/or linear and/or branched C₃-C₁₆ olefins.

Some examples of suitable activators may include, but are not limited to, propylene, isopropyl alcohol, 1-propanol, n-butene, 2-butene, 1-butanol, 2-butanol, tert-butyl alcohol, iso-butyl alcohol, isobutylene, 4-methyl-1-pentene, 2,4,4, trimethyl-1-pentene, and combinations thereof.

In embodiments, a reaction product of the present process can be utilized as an activator. For example, a C₃-C₁₆ olefin product can be separated from the reactor effluent and be recycled to the reactor as an activator. In embodiments, a C₆-C₈ olefin product can be separated from the reactor effluent to be utilized as the activator.

In embodiments, the activator feed can be sourced from a refinery process which contains linear and/or branched C₃+ alcohols and/or linear and/or branched C₃+ olefins. In embodiments, the activator may be sourced from a fluidized catalytic cracker unit (FCCU) effluent. For example, olefins such as ethylene, propylene, butylenes, and isobutylenes can be produced in an FCCU and be used as activators in the present process.

In embodiments, the activator feed can be sourced from a coker such as coker naphtha. Coker naphtha is a complex combination of hydrocarbons produced by the distillation of products from a coker unit such as a fluid coker. Coker naphtha is primary composed of unsaturated hydrocarbons having carbon numbers predominantly in the range of C₄ through C₁₅ and boiling in the range of approximately 43° C. to 250° C. Coker naphtha or a fractional cut of coker naphtha, such as C₃-C₈ olefins, may be produced and/or separated from a coker unit and be used as activators in the present process.

In embodiments, the activators can be sourced from thermal cracking (steam cracking) and/or catalytic cracking of hydrocarbons such as naphtha, gasoil, light hydrocarbons such as ethane, propane, butanes, and other suitable cracking feeds. An effluent from a thermal cracking and/or catalytic cracking unit may be produced and/or separated from a thermal cracking and/or catalytic cracking unit and be used as activators in the present process.

In embodiments, the activators may be sourced from wastewater treatment. Various units within a refinery or chemical plant may utilize water to carry out separations, washes, and other operations. Water may also be produced as a product in some petrochemical processes. Wastewater, such as naphtha-containing wastewater, may include olefins such as C₃-C₆ olefins, which are suitable for use as activators in the present process. Wastewater from chemical processes which contain C₃-C₁₆ olefins can be used as an activator in the present process. There may be several advantages to utilizing wastewater, including the conversion of C₃-C₁₆ olefins in the wastewater to a higher value jet-range product, and less contamination of the wastewater such that the wastewater is easier to treat.

In embodiments, the alcohol and/or activator may be derived from biogenic carbon. The biogenic carbon is disparate from non-biogenic carbon, such as petroleum carbon, and can be identified using radiometric analysis techniques. When alcohol and activators containing 100 wt. % biogenic carbon are used in the process, the jet range hydrocarbons produced will also contain 100 wt. % biogenic carbon. Thus, the entirety of the jet range hydrocarbons can be derived from renewable resources. In embodiments, the alcohols and/or activator utilized in the present process can contain at least 95 wt. % biogenic carbon as measured by ASTM D6866. Alternatively, the alcohol and/or activators contain at least 90 wt. % biogenic carbon, at least 85 wt. % biogenic carbon, at least 80 wt. % biogenic carbon, at least 75 wt. % biogenic carbon, at least 70 wt. % biogenic carbon, at least 65 wt. % biogenic carbon, at least 60 wt. % biogenic carbon, at least 55 wt. % biogenic carbon, or at least 50 wt. % biogenic carbon. In embodiments, the alcohol and/or activator can contain from about 50 wt. % to about 100 wt. % biogenic carbon. Alternatively, from about 50 wt. % biogenic carbon to about 75 wt. % biogenic carbon, from about 75 wt. % biogenic carbon to about 90 wt. % biogenic carbon, from about 90 wt. % biogenic carbon to about 100 wt. % biogenic carbon, or any ranges therebetween. In embodiments, the alcohol and/or activator can contain 1 wt. % to 100 wt. % biogenic carbon. Alternatively, the alcohol and/or activator can contain 1 wt. % to 10 wt. % biogenic carbon, 10 wt. % to 20 wt. % biogenic carbon, 20 wt. % to 30 wt. % biogenic carbon, 30 wt. % to 40 wt. % biogenic carbon, 40 wt. % to 50 wt. % biogenic carbon, 50 wt. % to 60 wt. % biogenic carbon, 60 wt. % to 70 wt. % biogenic carbon, 70 wt. % to 80 wt. % biogenic carbon, 80 wt. % to 90 wt. % biogenic carbon, 90 wt. % to 100 wt. % biogenic carbon, or any ranges therebetween.

### Catalyst Description

A variety of solid acid catalysts have acidity suitable to catalyze the reactions to produce C₆-C₁₆ olefins from alcohols and activators. Ideal solid acid catalysts have high activity, low deactivation rate, and selectivity to C₈+ hydrocarbons. As discussed above, water formed in dehydration may bind to the acid sites of the solid acid catalyst which lowers catalyst activity to subsequent dimerization and oligomerization reactions. While increasing temperature typically increases the oligomerization rate, excessive temperatures can promote cracking reactions over acidic sites thereby resulting in lower carbon number products outside jet range hydrocarbons. In some solid acid catalysts, cracking can also happen at relatively lower temperatures. Ideally, the solid acid catalyst should have higher selectivity to C₈+ hydrocarbons and lower selectivity to cracking at operating temperatures. As such, a suitable solid acid catalyst may have a balance of acid strength and an affinity for water such that oligomerization reactions can occur at relatively lower temperatures and should be resistant to degradation at operating conditions for the reactions.

Jet range hydrocarbons comprising branched chain paraffins are used in jet fuel blending to impart desirable properties to the jet fuel such as cold pour point and cloud point, for example. Shape selectivity, or selectivity to branched chain olefins, in the oligomerization reaction may be advantageous to produce branched hydrocarbons suitable for use in jet fuel applications. While small hydrocarbons (e.g., C₄ or lower) may easily diffuse into a zeolite pore, large hydrocarbons resulting from oligomerization may not diffuse out of the pore which may block the active site of the zeolite catalyst for performing other reactions and simultaneously subjects the hydrocarbon product to conditions which may be favorable for cracking. Thus, the active sites in the solid acid catalyst may be selected have the correct shape and size to yield branched C₈-C₁₆ hydrocarbons while not being too small to become clogged from higher molecular weight products.

In embodiments, suitable solid acid catalysts include those catalysts which have dehydrating and oligomerization functionality such as zeolites with acidic sites. Some examples of suitable solid acid catalyst catalysts include zeolite solid acid catalysts having at least 8-membered ring pores including zeolites with 8 membered ring pores, zeolites with 10-membered ring pores, zeolites with 12-membered ring pores, and zeolites with 14-membered ring pores. In embodiments suitable solid acid catalysts silica-alumina materials with 8, 10, 11-, 12, and 14 membered rings.

In embodiments, suitable solid acid catalysts can have a framework such as, without limitation, MWW, MFI, MRE*, MTW, DON, FAU, -ITN*, -EWT, BEA, MOR, DDR, FER, SZR, EUO, MTT, TON, MEL, MFS, IMF, MSE, MEI, IWV, EMT, MAZ, LTL, and combinations thereof.

In embodiments, the solid acid catalyst includes zeolites such as, without limitation, EMC-2, EMM-10, EMM-12, EMM-13, EMM-20, EMM-23, EMM-34, EMM-57, EMM-72, ERB-1, ITQ-1, ITQ-2, ITQ-27, ITQ-39, MCM-22, MCM-36, MCM-49, MCM-56, MCM-68, MIT-1, PSH-3, SUZ-4, SSZ-25, USY, H-form USY, NH4-USY, USC-Beta, UZM-8, UZM-8HS, UZM-37, ZSM-5, ZSM-11, ZSM-12, ZSM-18, ZSM-22, ZSM-23, ZSM-35, ZSM-48, ZSM-58, ZSM-50, ZSM-57, COK-5, Mazzite, Linde Type L, and combinations thereof.

In embodiments, the solid acid catalyst includes aluminosilicate materials having a silica to alumina molar ratio of at least 5, such as from 5 to 200. Alternatively, having a silica to alumina molar ratio of 5 to 10, 10 to 20, 20 to 30, 30 to 40, 40 to 50, 50 to 100, 100 to 150, 150 to 200 or any ranges therebetween. In embodiments, one or more heteroatoms such as Ti, Nb, Ta, and Sn may be present in the solid acid catalyst, as referenced above. In embodiments, the solid acid catalyst may include a crystalline material such as ferrierite or quartz present in a quantity of less than about 10 wt. %, or less than about 5 wt. %. In embodiments, ion exchange may be performed on a zeolite solid acid catalyst such as with ammonium nitrate, for example. In embodiments, the solid acid catalyst further includes metals such as ruthenium, rhodium, palladium, osmium, iridium, and platinum, tin, and combinations thereof.

### Binders

A zeolite solid acid catalyst may include a binder. Such binders may include active and inactive materials and synthetic or naturally occurring zeolites as well as inorganic materials such as clays and/or oxides such as alumina, silica, silica-alumina, zirconia, titania, magnesia, or mixtures of these and other oxides. The latter may be either naturally occurring or in the form of gelatinous precipitates or gels including mixtures of silica and metal oxides. Clays may also be included with oxide-type binders to modify the mechanical properties of the catalyst or to assist in its manufacture. The relative proportions of zeolite and binder may vary widely. For example, the binder may be present in an amount of 0.01 wt. % to 50 wt. %. Alternatively, from 0.01 wt. % to 1 wt. %, 1 wt. % to 5 wt. %, 5 wt. % to 10 wt. %, 10 wt. % to 20 wt. %, 20 wt. % to 30 wt. %, 30 wt. % to 40 wt. %, 40 wt. % to 50 wt. %, or any ranges therebetween.

In embodiments, the solid acid catalyst includes a zeolite having an MWW framework. As used herein, a solid acid catalyst having an MWW framework may include one or more of: a) molecular sieves made from a common first-degree crystalline building block unit cell, where the unit cell has the MWW framework topology; b) molecular sieves made from a common second-degree building block with a 2-dimensional tiling of such MWW framework topology unit cells, forming a monolayer of one unit cell thickness; and c) molecular sieves made from common second-degree building blocks, with layers of one or more than one unit cell thickness, wherein the layer of more than one unit cell thickness is made from stacking, packing, or binding at least two monolayers of MWW framework topology unit cells. The stacking of such second-degree building blocks can be in a regular fashion, an irregular fashion, a random fashion, or any combination thereof. Molecular sieves made by any regular or random 2-dimensional or 3-dimensional combination of unit cells having a MWW framework may also be made.

Solid acid catalysts having a MWW framework may include molecular sieves having an X-ray powder diffraction pattern including d-spacing maxima at 12.4±0.25, 6.9±0.15, 3.57±0.07 and 3.42±0.07 Å. The X-ray powder diffraction data used for such characterization may be obtained by standard techniques using the K-alpha doublet of copper as incident radiation and a diffractometer equipped with a scintillation counter and an associated computer as the collection system.

Other catalysts suitable in the present process include non-zeolitic solid acid catalysts. Some examples of non-zeolitic solid acid catalysts include, without limitation, heteropolyacids, mixed metal oxides, including but not limited to mixed metal oxide that is at least partially crystalline and comprises tungsten, zirconium, and a variable oxidation state metal selected from the group consisting of Fe, Mn, Co, Cu, Ce, Ni and any combination thereof, and silica-alumina hydrates containing Brønsted-acidic sites. In embodiments, heteropolyacids can include, without limitation, Cs_{2.5}PW₁₂O₄₀, H₃PW₁₂O₄₀, H₃PMo₁₂O₄₀, H₃PMo₆V₆O₄₀, H₅PMo₁₀V₂O₄₀, and combinations thereof.

These solid acid catalysts exhibit a good balance between acid strength and tolerance toward water, thereby allowing conversion of alcohols, such with an activator into C₆-C₁₆ olefins at relatively lower reaction temperatures, which may lower the selectivity to cracking reactions. Moreover, the water tolerance of the solid acid catalysts allows the dehydration and oligomerization reactions to produce C₆-C₁₆ olefins, including conversions taking place within a single reactor, thereby affording further advantages over other previously practiced processes requiring multiple reactors with separations between the reactors. Additionally, the solid acid catalysts can readily form C₈, C₁₂, and C₁₆ olefins as predominant products. In addition, the C₈₊ olefins formed from alcohol in the present process are predominantly branched hydrocarbons. It is believed that much of the conversion activity of zeolite solid acid catalysts having the frameworks described above occurs at acid sites in pockets on the exterior surface of the catalyst, which are less prone to active site blockage. The solid acid catalyst catalysts described herein may convert alcohols and activator to jet range hydrocarbons with a product distribution of C₆-C₁₆ olefins may be advantageously processed into jet fuel and other value products.

It is believed that water interacts with the active acid sites of the zeolite solid acid catalysts to afford active sites having a modified acid strength sufficient to promote further dehydration and subsequent olefin oligomerization. In the fermentation process for producing ethanol, water is also generated as a product. As will be shown in the Examples section below, the process to convert alcohol to jet range hydrocarbons does not require “dry” alcohol feed and the alcohol can be co-fed with water in the process to produce jet range hydrocarbons with little to no impact on the catalyst performance such as activity, selectivity, and stability. The ability to co-feed water, especially in embodiments where the alcohol is a product of fermentation, allows for a diverse source of feeds to be utilized in the present process.

In embodiments, water is co-fed with alcohol and activator in an amount of 0.01 wt. % to 50 wt. % by weight of the feed. Alternatively, water is co-fed with alcohol and activator in an amount of from 0.01 wt. % to 5 wt. % by weight of the feed, from 5 wt. % to 10 wt. % by weight of the feed, 10 wt. % to 20 wt. % by weight of the feed, 20 wt. % to 30 wt. % by weight of the feed, 30 wt. % to 40 wt. % by weight of the feed, 40 wt. % to 50 wt. % by weight of the feed, or any ranges therebetween.

### Process Conditions for Making Jet Range Hydrocarbons

In embodiments, the process for producing jet range hydrocarbons includes introducing an alcohol and an activator into a reactor containing a solid acid catalyst and contacting the alcohol and the activator in the presence of the solid acid catalyst to produce C₆-C₁₆ olefins.

In embodiments, the activator and alcohol may be present in any suitable amount to convert a desired fraction of the alcohol to produce the C₆-C₁₆ olefins. For example, the feed to the reactor may contain 25 wt. % alcohol to 99 wt. % alcohol. Alternatively, the feed to the reactor may contain 1 wt. % to 25 wt. % alcohol, 25 wt. % to 35 wt. % alcohol, 35 wt. % to 45 wt. % alcohol, 45 wt. % to 55 wt. % alcohol, 55 wt. % to 65 wt. % alcohol, 65 wt. % to 75 wt. % alcohol, 75 wt. % to 85 wt. % alcohol, 85 wt. % to 95 wt. % alcohol, 95 wt. % to 99 wt. % alcohol, or any ranges therebetween.

In embodiments, the feed to the reactor may contain 1 wt. % activator to 99 wt. % activator. Alternatively, the feed to the reactor may contain 1 wt. % to 5 wt. % activator, 5 wt. % to 10 wt. % activator, 10 wt. % to 15 wt. % activator, 15 wt. % to 20 wt. % activator, 20 wt. % to 25 wt. % activator, 25 wt. % to 35 wt. % activator, 35 wt. % to 45 wt. % activator, 45 wt. % to 55 wt. % activator, 55 wt. % to 65 wt. % activator, 65 wt. % to 75 wt. % activator, 75 wt. % to 85 wt. % activator, 85 wt. % to 95 wt. % activator, 95 wt. % to 99 wt. % activator, or any ranges therebetween.

In embodiments, the feed to the reactor may contain reaction products introduced through a recycle stream. For example, the feed to the reactor can contain reaction products such as ethers, olefins, water, and combinations thereof. In embodiments, the reaction products may be present in the feed to the reactor in an amount of 5 wt. % activator to 99 wt. % of the feed. Alternatively, the feed to the reactor may contain 5 wt. % to 15 wt. % reaction products, 15 wt. % to 25 wt. %, 25 wt. % to 35 wt. % reaction products, 35 wt. % to 45 wt. % reaction products, 45 wt. % to 55 wt. % activator, 55 wt. % to 65 wt. % activator, 65 wt. % to 75 wt. % activator, 75 wt. % to 85 wt. % activator, 85 wt. % to 95 wt. % activator, 95 wt. % to 99 wt. % activator, or any ranges therebetween.

In embodiments the alcohol and activator may be reacted in the reactor at any suitable temperature including at a temperature at a point in a range of 125° C. to 300° C. Alternatively, the alcohol and activator may be reacted at a temperature at a point in a range of 125° C. to 150° C., 150° C. to 175° C., 175° C. to 200° C., 200° C. to 225° C., 225° C. to 250° C., 250° C. to 275° C., 275° C. to 300° C., or any ranges therebetween.

In embodiments the alcohol and activator may be reacted in the reactor at any suitable pressure including at a pressure in a range of from atmospheric (101.325 kPa) to 7000 kPa. Alternatively, the alcohol and activator may be reacted a pressure (absolute or gauge) at a point in a range of from 101.325 kPa to 1000 kPa, 1000 kPa to 2000 kPa, 2000 kPa to 2500 kPa, 2500 kPa to 3000 kPa, 3000 kPa to 3500 kPa, 3500 kPa to 4000 kPa, 4000 kPa to 4500 kPa, 4500 kPa to 5200 kPa, or any ranges therebetween.

The reactor may be operated at any suitable LHSV, for example from 0.25 hour⁻¹ to 6 hour⁻¹. Alternatively, from 0.25 hour⁻¹ to 1 hour⁻¹, 1 hour⁻¹ to 2 hour⁻¹, 2 hour⁻¹ to 3 hour⁻¹, 3 hour 1 to 4 hour⁻¹, 4 hour⁻¹ to 5 hour⁻¹, 5 hour⁻¹ to 6 hour⁻¹, or any ranges therebetween.

In embodiments, the per pass conversion of the alcohol may be dependent upon the identity of the alcohol, activator, and solid acid catalyst used as well as process conditions. Generally, the per pass conversion of the alcohol may range from 20 wt. % to 100 wt. %. Alternatively, from 20 wt. % to 50 wt. %, 50 wt. % to 75 wt. %, 75 wt. % to 100 wt. %, or any ranges therebetween.

The selectivity for C₈ and below versus C₉₊ olefin oligomers may be controlled by adjusting feed conditions such as co-fed water or reactor conditions. In embodiments, the selectivity to C₈₊ olefins may be from 20 wt. % to 100 wt. %. Alternatively, from 20 wt. % to 40 wt. %, 40 wt. % to 60 wt. %, 60 wt. % to 80 wt. %, 80 wt. % to 100 wt. %, or any ranges therebetween. In embodiments, the selectivity to C₁₂₊ olefins may be from 20 wt. % to 100 wt. %. Alternatively, from 20 wt. % to 40 wt. %, 40 wt. % to 60 wt. %, 60 wt. % to 80 wt. %, 80 wt. % to 100 wt. %, or any ranges therebetween.

In embodiments, the alcohol and activator are contacted with the catalyst in a single reactor or vessel. In a particular example, the alcohol and activator may be contacted with the solid acid catalyst at or near the top of the reactor vessel, and the olefin product may be obtained from the bottom of the reactor vessel. The solid acid catalyst may be arranged in a fixed bed configuration when contacting the alcohol and activator in this manner, such that the alcohol, activator, and olefin product progress in a trickle bed fashion through the reactor. Unconverted alcohol obtained from the reactor may be separated from the olefin product and recycled to the alcohol feed supplying the reactor. Alternately, other reactor configurations such as batch, fluidized bed, and/or slurry reactors may be used.

In embodiments, the alcohol and the activator may be mixed together and introduced into the reactor. In further embodiments, the alcohol may be introduced into the reactor and the activator can be introduced into one or more points along the reactor in a multipoint injection method. In further embodiments, the alcohol and activator may be mixed and introduced into the reactor and additional activator may be introduced into one or more points along the reactor in a multipoint injection method.

In embodiments, the C₆-C₁₆ olefins produced from reacting the activator and alcohol in the presence of the solid acid catalyst are hydrogenated to saturate the olefins to produce corresponding C₆-C₁₆ paraffins. The hydrogenation reaction can be carried out in a hydrogenation reactor containing a hydrogenation catalyst, such as catalysts containing platinum, palladium, and/or nickel, for example. The hydrogenation reactor may be operated at any suitable temperature such as in a range of 150° C. to 230° C. and a pressure range of 2000 kPa to 7000 kPa.

An effluent from the hydrogenation reactor can include C₆-C₁₆ mono, di, tri, and higher order branched isoparaffins. In embodiments where a feed to the hydrogenation reactor includes aromatics, a catalyst and process conditions can be selected such that none or a portion of the aromatics are hydrogenated. In such embodiments, an effluent from the hydrogenation reactor can include the aromatics not hydrogenated.

After formation, a product of the present disclosure may be conveyed through a product outlet to a separation stage. Various fractions of the product may be separated from each other in the separation stage and/or water may be removed from the product or a fraction thereof. Unconverted alcohol and activator remaining in a product may be separated and recycled to the feed, if desired, entering at the top of the reactor vessel. The remaining hydrocarbons may be subjected to further processes to isolate desired fractions, such as C₈ olefin oligomers or C₁₂+ olefin oligomers. In a particular example, dimethylhexane may be isolated as a valuable fraction from a product following hydrogenation. Isolated fractions of a product may be conveyed to further downstream processes, if necessary, to generate commercially valuable isoparaffin products such as solvents and fuels.

### Description of Product

In embodiments, an effluent from the reactor containing the solid acid catalysts includes C₈ to C₂₄ olefins. In particular, a product formed in accordance with the present disclosure includes a blend of C₈ to C₁₆ olefins and isomeric forms thereof having a wide range of numbers of branches, different branch locations, lengths, and further substitution. The C₈ to C₁₆ olefins may have include or more double bonds varying in locations and total number per molecule. Branching in a product as a whole may be characterized by the branch index. A C₈ to C₁₆ olefins product obtained according to the present disclosure may have a branch index of 1 or greater, indicating that a majority of the C₈ to C₁₆ olefins have at least one branch. Any given C₈ to C₁₆ olefin in a product may be mono-branched, dibranched, tribranched or have four or greater branches. In a particular example, at least about 90 wt. % of C₈ to C₁₆ olefins may have at least one branch.

Branch Index within the C₈ to C₁₆ olefins equals (0×% linear olefins+1×% monobranched olefins+2×% dibranched olefins+3×% tribranched olefins)/100; where % linear olefins+% monobranched olefins+% dibranched olefins+% tribranched olefins=100%. More highly branched individual olefins (e.g., tetrabranched and higher) may be weighted similarly to determine the branch index. For example, a mixture of C₈ olefin oligomers composed of 10% linear C₈, 30% monobranched C₈, 50% dibranched C₈, and 10% tribranched C₈ has a branch index of 1.6.

In embodiments, the reactor effluent includes at least 40 wt. % C₈ to C₁₆ olefins. Alternatively, from 40 wt. % to 100 wt. % C₈ to C₁₆ olefins. Alternatively, from 40 wt. % to 50 wt. % C₈ to C₁₆ olefins, from 50 wt. % to 60 wt. % C₈ to C₁₆ olefins, from 60 wt. % to 70 wt. % C₈ to C₁₆ olefins, from 70 wt. % to 80 wt. % C₈ to C₁₆ olefins, from 80 wt. % to 90 wt. % C₈ to C₁₆ olefins, from 90 wt. % to 100 wt. % C₈ to C₁₆ olefins, or any ranges therebetween.

In embodiments, the reactor effluent includes C₁₀ to C₂₂ aromatics, styrenes, and/or quad olefins in an amount from 1 wt. % to 40 wt. %. Alternatively, from 1 wt. % to 10 wt. %, from 10 wt. % to 20 wt. %, from 20 wt. % to 30 wt. %, from 30 wt. % to 40 wt. %, or any ranges therebetween.

In embodiments, the reactor effluent includes C₄ to C₂₄ oxygenates such as ketones, aldehydes, and ethers, for example in an amount from 1 wt. % to 10 wt. %. Alternatively, from 1 wt. % to 3 wt. %, from 3 wt. % to 5 wt. %, from 5 wt. % to 7 wt. %, from 7 wt. % to 10 wt. %, or any ranges therebetween.

In embodiments, an effluent from the reactor containing the solid acid catalysts includes at least one additional compound such as a C₃ to C₁₆ paraffin, C₃ to C₁₆ cycloparaffin, C₃ to C₁₆ dicycloparaffin, C₃ to C₁₆ tricycloparaffin, benzene, C₃ to C₁₆ tetracycloparaffin, tetralin and C₁₁ to C₁₆ derivatives and isomers thereof, indane and C₁₀ to C₁₆ derivatives and isomers thereof, dicyclic benzenes, indene and C₁₀ to C₁₆ derivatives and isomers thereof, naphthalene and C₁₁ to C₁₆ derivatives and isomers thereof, bi-phenyl and C₁₃ to C₁₆ derivatives and isomers thereof, fluorene and C₁₄ to C₁₆ derivatives and isomers thereof, C₃ to C₁₆ alcohols and derivatives and isomers thereof, C₃ to C₁₆ ethers and derivatives and isomers thereof, C₃ to C₁₆ aldehydes and derivatives and isomers thereof, C₃ to C₁₆ ketones and derivatives and isomers thereof, C₆ to C₁₆ cyclic ketones and derivatives and isomers thereof, furan and C₅ to C₁₆ derivatives and isomers thereof, phenol and C₇ to C₁₆ derivatives and isomers thereof, benzyl aldehyde, benzyl ketone, benzofuran and C₉ to C₁₆ derivatives and isomers thereof, naphthol, indenofuran and C₁₃ to C₁₆ derivatives and isomers thereof, dibenzofuran and C₁₃ to C₁₆ derivatives and isomers thereof, and combinations thereof. In embodiments, an effluent from the reactor containing the solid acid catalysts includes the additional compound in an amount of from about 1 wt. % to about 50 wt. % of the reactor effluent. Alternatively, from 1 wt. % to 10 wt. %, from 10 wt. % to 20 wt. %, from 20 wt. % to 30 wt. %, from 3 wt. % to 40 wt. %, from 40 wt. % to 50 wt. %, or any ranges therebetween.

In embodiments, an effluent from the reactor containing the solid acid catalysts includes water. The water may be present in an amount of from about 1 wt. % to about 50 wt. % of the reactor effluent. Alternatively, from 1 wt. % to 10 wt. %, from 10 wt. % to 20 wt. %, from 20 wt. % to 30 wt. %, from 3 wt. % to 40 wt. %, from 40 wt. % to 50 wt. %, or any ranges therebetween.

The solid acid catalysts used in the present disclosure may exhibit low cracking activity. Thus, any product formed in accordance with the disclosure herein may comprise a low percentage of C₃₋ hydrocarbons including olefins and paraffins. In a particular example, less than about 0.01 wt. % of the alcohol and activator may be converted into C₃₋ hydrocarbons. Preferably, a product formed in accordance with the present disclosure may contain no C₃₋ hydrocarbons in combination with the olefins. In other examples, a product formed in accordance with the present disclosure may include less than about 0.01 wt. % (i.e., from 0 wt. % to about 0.01 wt. %) C₃₋ hydrocarbons based on the total weight of the product.

In embodiments, the effluent stream from the reactor and/or the hydrotreatment unit in the present process can contain at least 95 wt. % biogenic carbon as measured by ASTM D6866. Alternatively, the effluent stream from the reactor and/or the hydrotreatment unit at least 90 wt. % biogenic carbon, at least 85 wt. % biogenic carbon, at least 80 wt. % biogenic carbon, at least 75 wt. % biogenic carbon, at least 70 wt. % biogenic carbon, at least 65 wt. % biogenic carbon, at least 60 wt. % biogenic carbon, at least 55 wt. % biogenic carbon, or at least 50 wt. % biogenic carbon. In embodiments, the effluent stream from the reactor and/or the hydrotreatment unit can contain from about 50 wt. % to about 100 wt. % biogenic carbon. Alternatively, from about 50 wt. % biogenic carbon to about 75 wt. % biogenic carbon, from about 75 wt. % biogenic carbon to about 90 wt. % biogenic carbon, from about 90 wt. % biogenic carbon to about 100 wt. % biogenic carbon, or any ranges therebetween. In embodiments, the effluent stream from the reactor and/or the hydrotreatment unit can contain 1 wt. % to 100 wt. % biogenic carbon. Alternatively, the alcohol and/or activator can contain 1 wt. % to 10 wt. % biogenic carbon, 10 wt. % to 20 wt. % biogenic carbon, 20 wt. % to 30 wt. % biogenic carbon, 30 wt. % to 40 wt. % biogenic carbon, 40 wt. % to 50 wt. % biogenic carbon, 50 wt. % to 60 wt. % biogenic carbon, 60 wt. % to 70 wt. % biogenic carbon, 70 wt. % to 80 wt. % biogenic carbon, 80 wt. % to 90 wt. % biogenic carbon, 90 wt. % to 100 wt. % biogenic carbon, or any ranges therebetween.

In embodiments, the reaction products of the alcohol and activator and/or reaction products from the hydrogenation unit, are used to processed into jet fuel by blending to meet a jet fuel specification such as ASTM D1655-22.

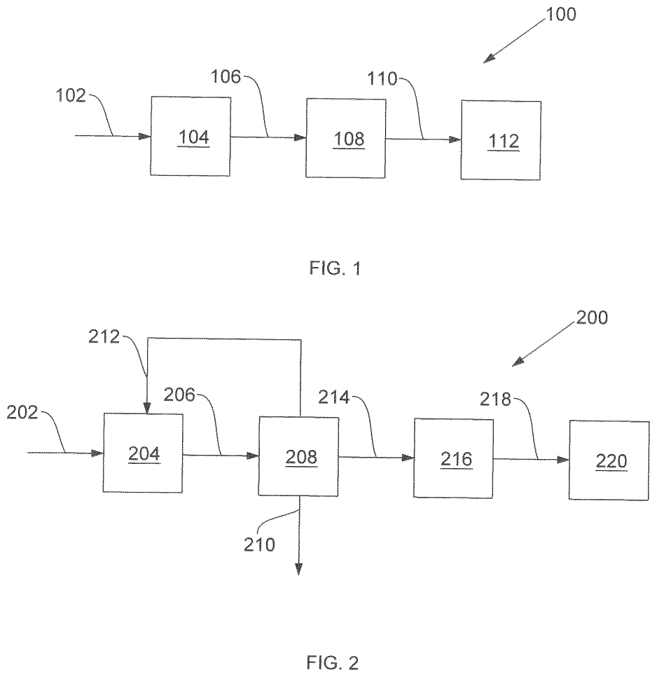

FIG. 1 is a block flow diagram illustrating a process 100 for producing jet range hydrocarbons from alcohols and activators in accordance with some embodiments disclosed herein. In FIG. 1, feed stream 102 containing alcohol and activator is introduced into reactor 104 containing a solid acid catalyst. Reactor 104 is operated at conditions suitable to convert at least a portion of the alcohol and activator in feed stream 102, in the presence of the solid acid catalyst, to produce olefins with carbon numbers in a range from C₆-C₁₆. Stream 106 containing the olefins produced in reactor 104 may be introduced into hydrotreatment unit 108. Hydrotreatment unit 108 may contain a hydrotreatment reactor operated at conditions suitable to saturate at least a portion of the olefins from stream 106 to form the corresponding C₆-C₁₆ saturated hydrocarbons. Stream 110 containing the saturated hydrocarbons produced in hydrotreatment unit 108 may be routed to jet blending pool 112 for blending to jet fuel.

FIG. 2. is a block flow diagram illustrating a process 200 for producing jet range hydrocarbons from alcohols and activators in accordance with some embodiments disclosed herein. In FIG. 2, feed stream 202 containing alcohol optionally activator is introduced into reactor 204 containing a solid acid catalyst. In embodiments, the activator can be introduced into the reactor 204 at multiple points in multipoint injection methods. Reactor 204 is operated at conditions suitable to convert at least a portion of the alcohol and activator in feed stream 202, in the presence of the solid acid catalyst, to produce olefins with carbon numbers in a range from C₆-C₁₆. Stream 206 containing the olefins produced in reactor 204 may be introduced into separation unit 208 whereby the components of stream 206 may be separated. Separation unit 208 may include any suitable separation equipment for separating components of stream 206 such as drums, trayed columns, packed columns, absorption columns, and membrane separators, for example, as well as the associated necessary equipment for operating the separation equipment. For example, at least a portion of water generated from the dehydration of alcohol in feed stream 202 may be separated as water stream 210. A recycle stream 212 may also be separated which may contain unreacted alcohol as well as reaction products from reactor 204. In embodiments, recycle stream 212 contains olefin reaction products from reactor 204. An olefin containing stream 214 containing at least a portion of the olefins from stream 206 may be separated in separation unit 208 and introduced into hydrotreatment unit 216. Hydrotreatment unit 216 may contain a hydrotreatment reactor operated at conditions suitable to saturate at least a portion of the olefins from olefin containing stream 214 to form the corresponding C₆-C₁₆ saturated hydrocarbons. Stream 218 containing the saturated hydrocarbons produced in hydrotreatment unit 216 may be routed to jet blending pool 220 for blending to jet fuel.

In embodiments, feed stream 202 may include an initial feed to the reactor which contains both the alcohol and the activator. Once the reactor has been run for a period of time, the concentration of C₃-C₁₆ olefin in recycle stream 212 may be sufficient to sustain the reaction without further addition of activator via feed stream 202. Once an initial charge of activator has been used to start the reaction, the reaction may be self-sustaining without the need to supply additional activator.

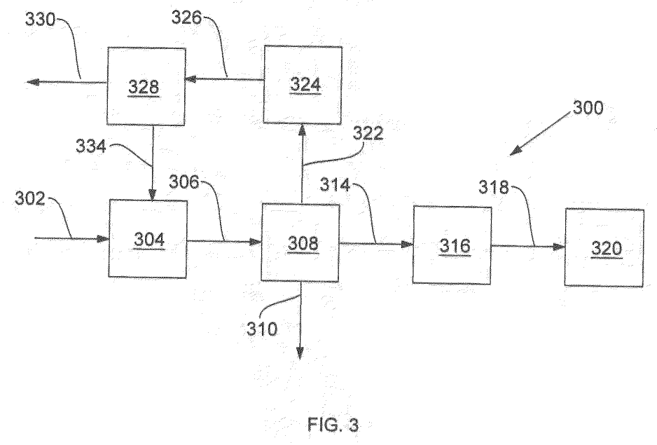

FIG. 3. is a block flow diagram illustrating a process 300 for producing jet range hydrocarbons from alcohols and activators in accordance with some embodiments disclosed herein. In FIG. 3, feed stream 302 containing alcohol and optionally activator is introduced into reactor 304 containing a solid acid catalyst. In embodiments, the activator can be introduced into the reactor 304 at multiple points in multipoint injection methods. Reactor 304 is operated at conditions suitable to convert at least a portion of the alcohol and activator in feed stream 302, in the presence of the solid acid catalyst, to produce olefins with carbon numbers in a range from C₆-C₁₆. Stream 306 containing the olefins produced in reactor 304 may be introduced into separation unit 308 whereby the components of stream 306 may be separated. Separation unit 308 may include any suitable separation equipment for separating components of stream 306 such as drums, trayed columns, packed columns, absorption columns, and membrane separators, for example, as well as the associated necessary equipment for operating the separation equipment. For example, at least a portion of water generated from the dehydration of alcohol in feed stream 302 may be separated as water stream 310. A recycle stream 322 may also be separated which may contain unreacted alcohol as well as reaction products from reactor 304. In embodiments, recycle stream 322 contains olefin reaction products from reactor 304.

Recycle stream 322 may be introduced into reactor 324 containing a solid acid catalyst whereby alcohol present in the recycle stream 322 may be reacted to form the corresponding ether and water. In embodiments, activator may also be introduced into reactor 324 to produce additional olefins. Stream 326 may be withdrawn from reactor and introduced into optional separation unit 328 which may separate a portion of water as water stream 330. Stream 334 containing components of recycle stream 322 and any additionally generated species from reactor 324 may be introduced into reactor 304.

In embodiments, feed stream 302 may include an initial feed to the reactor which contains both the alcohol and the activator. Once the reactor has been run for a period of time, the concentration of C₃-C₁₆ olefin in recycle stream 322 may be sufficient to sustain the reaction without further addition of activator via feed stream 302. Once an initial charge of activator has been used to start the reaction, the reaction may be self-sustaining without the need to supply additional activator.

An olefin containing stream 314 containing at least a portion of the olefins from stream 306 may be separated in separation unit 308 and introduced into hydrotreatment unit 316. Hydrotreatment unit 316 may contain a hydrotreatment reactor operated at conditions suitable to saturate at least a portion of the olefins from olefin containing stream 314 to form the corresponding C₆-C₁₆ saturated hydrocarbons. Stream 318 containing the saturated hydrocarbons produced in hydrotreatment unit 316 may be routed to jet blending pool 320 for blending to jet fuel.

The methods and systems disclosed may include any of the various features disclosed herein, including one or more of the following embodiments.

Embodiment 1. A method comprising: introducing a feed comprising an alcohol and an activator into a reactor comprising a solid acid catalyst; and contacting the alcohol and the activator with the solid acid catalyst under conditions effective to convert at least a portion of the alcohol and the activator to produce a product stream comprising C₆-C₁₆ olefins.

Embodiment 2. The method of statement 1 wherein the alcohol has a carbon number in a range from C₁ to C₇.

Embodiment 3. The method of any of embodiments 1-2 wherein the alcohol comprises ethanol.

Embodiment 4. The method of any of embodiments 1-3 where in the activator comprises a C₃-C₁₆ alcohol and/or C₃-C₁₆ olefin.

Embodiment 5. The method of any of embodiments 1-4 wherein the activator comprises at least one activator selected from the group consisting of propylene, isopropyl alcohol, 1-propanol, n-butene, 2-butene, 1-butanol, 2-butanol, tert-butyl alcohol, iso-butyl alcohol, isobutylene, 4-methyl-1-pentene, 2,4,4, trimethyl-1-pentene, and combinations thereof.

Embodiment 6 The method of any of embodiments 1-5 wherein the alcohol and/or the activator contain at least 50 wt. % biogenic carbon as measured by ASTM D6866.

Embodiment 7. The method of any of embodiments 1-6 wherein the activator comprises an olefin activator, wherein the olefin activator is separated from an effluent from a fluidized catalytic cracker unit, an effluent from a coker unit, an effluent from a cracking unit, or combinations thereof.

Embodiment 8. The method of any of embodiments 1-7 wherein the solid acid catalyst comprises silica-alumina materials with 8, 10, 11, and/or 12 membered rings.

Embodiment 9. The method of any of embodiments 1-8 wherein the solid acid catalyst comprises a framework selected from the group consisting of MWW, MFI, MRE*, MTW, DON, FAU, -ITN*, -EWT, BEA, MOR, DDR, FER, SZR, EUO, MTT, TON, MEL, MFS, IMF, MSE, MEI, IWV, EMT, MAZ, LTL, and combinations thereof.

Embodiment 10. The method of any of embodiments 1-9 wherein the solid acid catalyst comprise a zeolite selected form the group consisting of EMC-2, EMM-10, EMM-12, EMM-13, EMM-20, EMM-23, EMM-34, EMM-57, EMM-72, ERB-1, ITQ-1, ITQ-2, ITQ-27, ITQ-39, MCM-22, MCM-36, MCM-49, MCM-56, MCM-68, MIT-1, PSH-3, SUZ-4, SSZ-25, USY, H-form USY, NH4-USY, USC-Beta, UZM-8, UZM-8HS, UZM-37, ZSM-5, ZSM-11, ZSM-12, ZSM-18, ZSM-22, ZSM-23, ZSM-35, ZSM-48, ZSM-58, ZSM-50, ZSM-57, COK-5, Mazzite, Linde Type L, and combinations thereof.

Embodiment 11. The method of any of embodiments 1-10 wherein the solid acid catalyst comprises at least one solid acid catalyst selected from the group consisting of Cs_{2.5}PW₁₂O₄₀, H₃PW₁₂O₄₀, H₃PMo₁₂O₄₀, H₃PMo₆V₆O₄₀, H₅PMo₁₀V₂O₄₀, mixed metal oxides, including but not limited to mixed metal oxide that is at least partially crystalline and comprises tungsten, zirconium, and a variable oxidation state metal selected from the group consisting of Fe, Mn, Co, Cu, Ce, Ni and any combination thereof, and silica-alumina hydrates containing Brønsted-acidic sites, and combinations thereof.

Embodiment 12. The method of any of embodiments 1-11 wherein the feed further comprises water and/or wastewater containing an olefin activator.

Embodiment 13. The method of any of embodiments 1-12 further comprising separating a portion of the C₆-C₁₆ olefins from the product stream and introducing the portion of the C₆-C₁₆ olefins into the reactor as a recycle stream.

Embodiment 14. The method of any of embodiments 1-13 further comprising: separating a recycle stream from the product stream, the recycle stream comprising unreacted alcohol; introducing the recycle stream into a second reactor comprising a solid acid catalyst; dehydrating at least a portion of the unreacted alcohol to form a corresponding ether in the second reactor; and introducing at least a portion of the corresponding ether into the reactor comprising a solid acid catalyst.

Embodiment 15. The method of any of embodiments 1-14 wherein the activator is introduced into the reactor at two or more points along a length of the reactor.

Embodiment 16. The method of any of embodiments 1-15 wherein the product stream further comprises at least one compound selected from the group consisting of a C₃ to C₁₆ paraffin, C₃ to C₁₆ cycloparaffin, C₃ to C₁₆ dicycloparaffin, C₃ to C₁₆ tricycloparaffin, benzene, C₃ to C₁₆ tetracycloparaffin, tetralin and C₁₁ to C₁₆ derivatives and isomers thereof, indane and C₁₀ to C₁₆ derivatives and isomers thereof, dicyclic benzenes, indene and C₁₀ to C₁₆ derivatives and isomers thereof, naphthalene and C₁₁ to C₁₆ derivatives and isomers thereof, bi-phenyl and C₁₃ to C₁₆ derivatives and isomers thereof, fluorene and C₁₄ to C₁₆ derivatives and isomers thereof, C₃ to C₁₆ alcohols and derivatives and isomers thereof, C₃ to C₁₆ ethers and derivatives and isomers thereof, C₃ to C₁₆ aldehydes and derivatives and isomers thereof, C₃ to C₁₆ ketones and derivatives and isomers thereof, C₆ to C₁₆ cyclic ketones and derivatives and isomers thereof, furan and C₅ to C₁₆ derivatives and isomers thereof, phenol and C₇ to C₁₆ derivatives and isomers thereof, benzyl aldehyde, benzyl ketone, benzofuran and C₉ to C₁₆ derivatives and isomers thereof, naphthol, indenofuran and C₁₃ to C₁₆ derivatives and isomers thereof, dibenzofuran and C₁₃ to C₁₆ derivatives and isomers thereof, and combinations thereof.

Statement 17. A method comprising: introducing a feed comprising ethanol and an activator comprising a C₃-C₁₆ alcohol and/or a C₃-C₁₆ olefin into a reactor; contacting the alcohol and the activator with a solid acid catalyst to produce at least C₈-C₁₆ olefins; and withdrawing a product stream from the reactor, the product stream comprising the C₈-C₁₆ olefins.

Embodiment 18. The method of embodiment 17 wherein the solid acid catalyst comprises silica-alumina materials with 8, 10, 11, and/or 12 membered rings.

Embodiment 19. The method of embodiment 17 wherein the solid acid catalyst comprises a framework selected from the group consisting of MWW, MFI, MRE*, MTW, DON, FAU, -ITN*, -EWT, BEA, MOR, DDR, FER, SZR, EUO, MTT, TON, MEL, MFS, IMF, MSE, MEI, IWV, EMT, MAZ, LTL, and combinations thereof.

Embodiment 20. The method of any of embodiments 16-17 wherein the solid acid catalyst comprise a zeolite selected form the group consisting of EMC-2, EMM-10, EMM-12, EMM-13, EMM-20, EMM-23, EMM-34, EMM-57, EMM-72, ERB-1, ITQ-1, ITQ-2, ITQ-27, ITQ-39, MCM-22, MCM-36, MCM-49, MCM-56, MCM-68, MIT-1, PSH-3, SUZ-4, SSZ-25, USY, H-form USY, NH4-USY, USC-Beta, UZM-8, UZM-8HS, UZM-37, ZSM-5, ZSM-11, ZSM-12, ZSM-18, ZSM-22, ZSM-23, ZSM-35, ZSM-48, ZSM-58, ZSM-50, ZSM-57, COK-5, Mazzite, Linde Type L, and combinations thereof, or wherein the solid acid catalyst comprises at least one solid acid catalyst selected from the group consisting of Cs_{2.5}PW₁₂O₄₀, H₃PW₁₂O₄₀, H₃PMo₁₂O₄₀, H₃PMo₆V₆O₄₀, H₅PMo₁₀V₂O₄₀, mixed metal oxides, including but not limited to mixed metal oxide that is at least partially crystalline and comprises tungsten, zirconium, and a variable oxidation state metal selected from the group consisting of Fe, Mn, Co, Cu, Ce, Ni and any combination thereof, and silica-alumina hydrates containing Brønsted-acidic sites, and combinations thereof.

Embodiment 21. A composition comprising: C₆-C₁₆ dibranched olefins in an amount of at least 40 wt. %; diethyl ether; water; and ethanol.

Embodiment 22. The composition of embodiment 21 further comprising at least one compound selected from the group consisting of a C₃ to C₁₆ paraffin, C₃ to C₁₆ cycloparaffin, C₃ to C₁₆ dicycloparaffin, C₃ to C₁₆ tricycloparaffin, benzene, C₃ to C₁₆ tetracycloparaffin, tetralin and C₁₁ to C₁₆ derivatives and isomers thereof, indane and C₁₀ to C₁₆ derivatives and isomers thereof, dicyclic benzenes, indene and C₁₀ to C₁₆ derivatives and isomers thereof, naphthalene and C₁₁ to C₁₆ derivatives and isomers thereof, bi-phenyl and C₁₃ to C₁₆ derivatives and isomers thereof, fluorene and C₁₄ to C₁₆ derivatives and isomers thereof, C₃ to C₁₆ alcohols and derivatives and isomers thereof, C₃ to C₁₆ ethers and derivatives and isomers thereof, C₃ to C₁₆ aldehydes and derivatives and isomers thereof, C₃ to C₁₆ ketones and derivatives and isomers thereof, C₆ to C₁₆ cyclic ketones and derivatives and isomers thereof, furan and C₅ to C₁₆ derivatives and isomers thereof, phenol and C₇ to C₁₆ derivatives and isomers thereof, benzyl aldehyde, benzyl ketone, benzofuran and C₉ to C₁₆ derivatives and isomers thereof, naphthol, indenofuran and C₁₃ to C₁₆ derivatives and isomers thereof, dibenzofuran and C₁₃ to C₁₆ derivatives and isomers thereof, and combinations thereof.

To facilitate a better understanding of the present invention, the following examples of certain aspects of some embodiments are given. In no way should the following examples be read to limit, or define, the entire scope of the disclosure.

### EXAMPLES

### General Setup

The reactor used in these experiments consists of a stainless-steel tube with dimensions of 0.375 inches (0.9525 cm) diameter, 20.5 inches (52.07 cm) in length, 0.035 inches (0.0889 cm) wall thickness. A piece of stainless-steel tubing 8.75 inches (22.225 cm) long with 0.375 inches (0.9525 cm) outer diameter and a piece of stainless-steel tubing 8.75 inches (22.225 cm) with 0.25 inches (0.635 cm) outer diameter tubing were placed one inside of the other at the bottom of the reactor as a spacer to position and support the catalyst in the isothermal zone of the furnace. A 0.25 inch (0.635 cm) plug of glass wool was placed at the top of the spacer to keep the catalyst in place. A 0.125 inch (0.3175 cm) stainless steel thermo-well was placed in the catalyst bed which was long enough to monitor temperature throughout the catalyst bed using a movable thermocouple.

Catalyst was prepared by mixing 5.0 cc of MCM-49 (95 wt. % MCM-49/5 wt. % silica), was sized to 14-25 mesh (710 micrometer) and blended with quarts chips for a total catalyst bed volume of 10 cc. The catalyst was then loaded into the reactor from the top to a height of 10 cm. A 0.25 inch (0.635 cm) glass wool plug was placed at the top of the catalyst bed to separate additional quartz chips from the catalyst bed. The remaining void space at the top of the reactor was filled with additional quartz chips. The reactor was installed in the furnace with the catalyst bed in the middle of the furnace at the pre-marked isothermal zone. The reactor was then pressure and leak tested at 800 psig (55.16 barg).

Two 500 cc syringe pumps were used to introduce the feed to the reactor. One pump was used for pumping ethanol and the second one for pumping activator. In some experiments, the ethanol and activator were individually fed to the reactor and in other experiments the ethanol and activator were blended together and introduced into the reactor if the ethanol and activator were miscible. A back pressure controller was used to control the reactor pressure, typically set at 750 psig (51.7 barg). On-line gas-chromatography (GC) analyses were taken to verify feed and the product composition.

The products exiting the reactor flowed through heated lines routed to the online GC sample location, then to chilled collection pots. The non-condensable gas products exiting the chilled collection pot overhead vents were routed through a gas pump for analysis. Samples from the collection pots were taken for analysis. Data from the reactor effluent online GC, vent gas online GC, and collection pots samples were combined to perform material balances at 24 hr intervals.

### Catalyst Synthesis

The MCM-49 catalyst used Example 1-4 was synthesized as described below. 95 parts MCM-49 and 5 parts silica (colloidal/precipitated), on a calcined dry weight basis, were combined in a muller. Sufficient water was added during the mixing process to produce an extrudable paste which was extruded to an extrudate and the extrudate was dried at 121° C. The dried extrudate was exchanged with 0.75 N ammonium nitrate to remove sodium. After ammonium nitrate exchange, the extrudate was washed with deionized water to remove residual nitrate ions prior to drying. The ammonium-exchanged extrudate was dried at 121° C. and heated in N2 to 538° C. and held for 3 hours. The temperature was decreased to 410° C. in nitrogen and then nitrogen was slowly decreased while oxygen was slowly increased to 21% while heating to 530° C. The catalyst was held at 530° C. and 21% O2 for 9 hours.

### Synthesis of Hydrocarbons

### Example 1

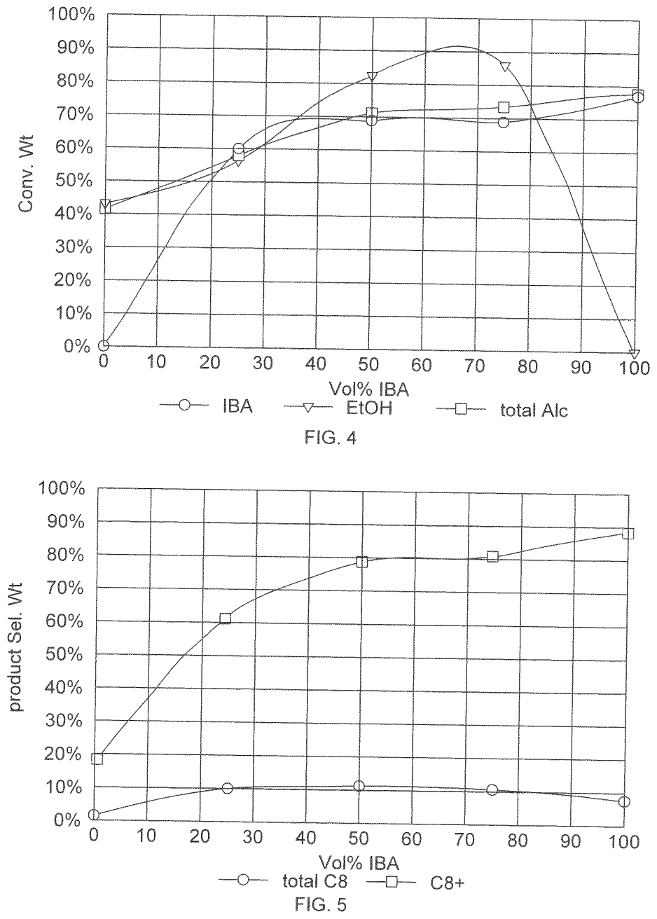

In this example, ethanol was converted to C8+ products using iso-butanol as the activator. Experiments were performed with varying weight ratios (100/0, 75/25, 50/50, 25/75, and 0/100) of ethanol to iso-butanol. Each experiment was run at 1 liquid hourly space velocity (LHSV), 750 psig (5171 kPa), and 190° C. The effluent from the reactor was analyzed by GC to verify the product composition. The results of the experiments are shown in FIG. 4 and FIG. 5. In FIG. 4 the volume percent of iso-butanol versus the conversion weight percent of ethanol is plotted. It was observed that increasing the volume fraction of the iso-butanol increased the conversion of the ethanol. In FIG. 5 volume percent of iso-butanol versus the conversion selectivity to total C8 and to C8+ products is plotted. It was observed that when the feed was 100% ethanol, the major product is diethyl ether, and when iso-butanol was included, increased selectivity to C8+ products was achieved.

### Example 2

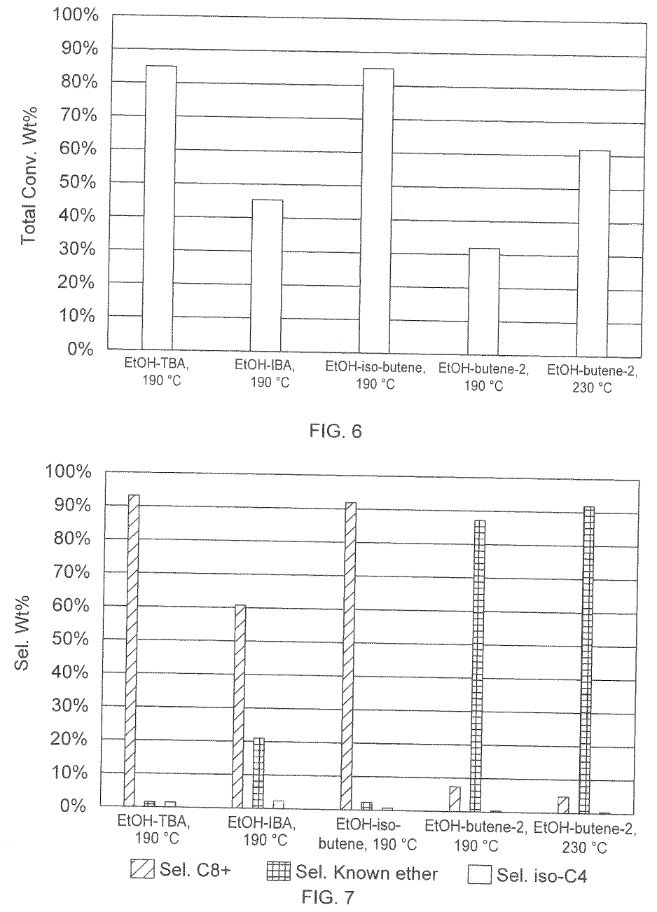

Another series of experiments was performed using the same reactor set up as before with varying the activator fed to the reactor with ethanol. In each of these experiments, the feed comprised 75 wt. % alcohol and 25 wt. % activator and the reactor was operated at 1 liquid hourly space velocity (LHSV), 750 psig (5171 kPa), and 190° C. The activators tested were iso-butyl alcohol, tert-butyl alcohol, isobutene, and 2-butene. FIG. 6 is a graph of the conversion weight percent of ethanol for each activator. It was observed that tert-butyl alcohol and isobutene had approximately the same conversion of ethanol at about 83 wt. %, isobutyl alcohol had a conversion of about 47 wt. %, and the 2-butene had a conversion of about 31 wt. %. One additional test of 2-butene 1 liquid hourly space velocity (LHSV), 750 psig (5171 kPa), and 230° C. was performed. It was observed that at 230° C. the conversion of ethanol using 2-butene was increased to approximately 61 wt. %. FIG. 7 is a graph of selectivity to C8+ species, iso-C4, and diethyl ether. It was observed that the selectivity of tert-butyl alcohol and isobutene to C8+ was about 91 wt. %, the 2-butene had a selectivity to C8+ of about 85 wt. %, and isobutyl alcohol had a selectivity to C8+ of about 61 wt. %. At 230° C., 2-butene had a selectivity to C8+ of about 91 wt. %.

### Example 3

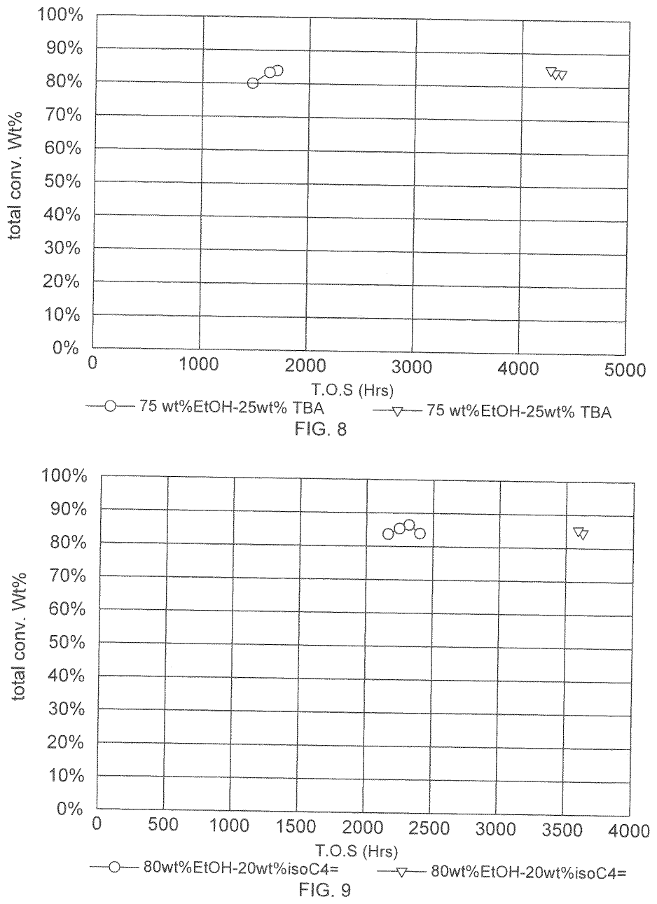

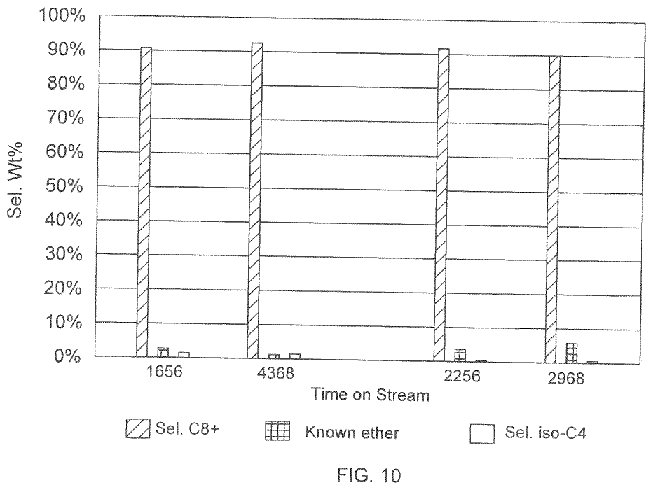

In this Example, catalyst stability was explored by using a blend of ethanol with varying activators at pressures of 150 psig (1034 kPa), 300 psig (2068 kPa), 500 psig (3447 kPa), and 750 psig (5171 kPa), temperatures of 140° C.-230° C., and LHSV of 0.25, 0.5, 0.75, and 1 hr⁻¹. The reactions were carried out for a few days at each condition and feed. FIG. 8 shows conversion weight percent of ethanol for 75 wt. % ethanol and 25 wt. % tert-butyl alcohol versus time on stream in hours. It was observed that the conversion of ethanol remained high throughout the experiment. FIG. 9 shows conversion weight percent of ethanol for 75 wt. % ethanol and 25 wt. % tert-butyl alcohol versus time on stream in hours. It was observed that the conversion of ethanol remained high throughout the experiment. FIG. 10 shows product selectivity for at different times on steam (TOS) using isobutylene or tert-butyl alcohol as an activator. It was observed that the selectivity to C8+ products remained high throughout the experiment.

### Example 4

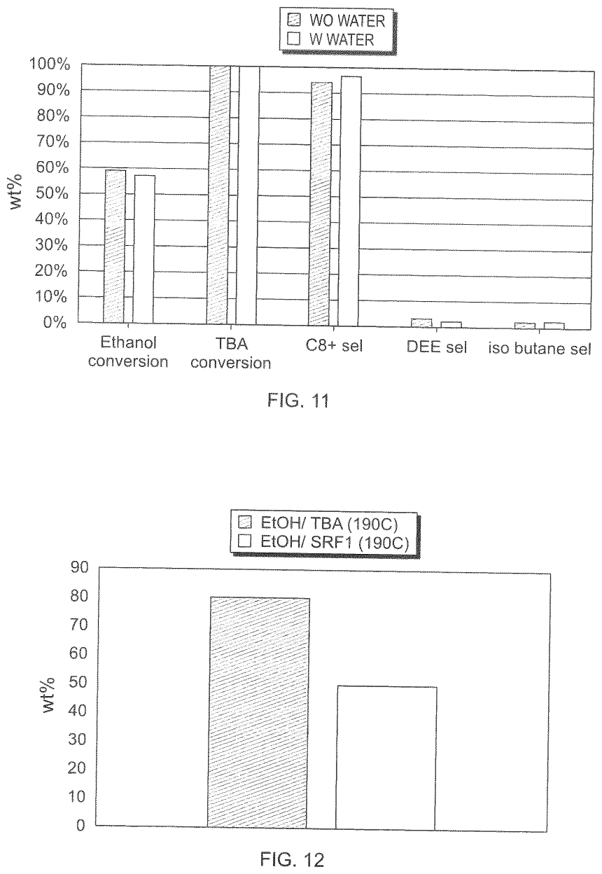

In this Example, water stability of the catalyst was explored using the catalyst and test set up as described above. The reactor pressure was set at 750 psig (5171 kPa) and 190° C. A first run was performed with 75 wt. % ethanol and 25 wt. % tert-butyl alcohol. A second run was performed with 72 wt. % ethanol, 20 wt. % tert-butyl alcohol, and 8% water blend at the same reactor conditions as the first run. FIG. 11 shows the results of the experiment with and without water. It was observed that co-feeding water slightly reduced the conversion of ethanol while providing slightly higher selectivity to C8+ hydrocarbons. The Example confirms that crude ethanol containing water can be utilized in the present process for producing jet range hydrocarbons.

### Example 5

In this Example, several catalysts were prepared and characterized.

Catalyst 1: 80/20 ZSM-5/Alumina. 80 parts ZSM-5 crystal (60/1 Si/Al2) and 20 parts pseudoboehmite alumina, on a calcined dry weight basis, were combined in a muller. Sufficient water was added during the mixing process to produce an extrudable paste and the mixture was extruded into a 1/16″ cylinder and then dried in an oven at 121° C. overnight. The dried extrudate was calcined in nitrogen @ 538° C. to decompose and remove the organic template. The nitrogen calcined extrudate was humidified with saturated air and exchanged with 1 N ammonium nitrate to remove sodium. After ammonium nitrate exchange, the extrudate was washed with deionized water and dried at 121° C. overnight. The catalyst was then calcined in air at 538° C.

Catalyst 2: 80/20 EMM-20/Alumina. 80 parts EMM-20 crystal (54/1 Si/Al2) and 20 parts pseudoboehmite alumina, on a calcined dry weight basis, were combined in a muller. Sufficient water was added during the mixing process to produce an extrudable paste and the mixture was extruded into a 1/16″ cylinder and then dried in an oven at 121° C. overnight. The dried extrudate was calcined in nitrogen @ 538° C. to decompose and remove the organic template. The nitrogen calcined extrudate was humidified with saturated air and exchanged with 1 N ammonium nitrate to remove sodium. After ammonium nitrate exchange, the extrudate was washed with deionized water and dried at 121° C. overnight. The catalyst was then calcined in air at 538° C.

Catalyst 3: 80/20 ZSM-48/Alumina. 80 parts of ZSM-48 crystal (70/1 Si/Al2) and 20 parts of pseudoboehmite alumina, on a calcined dry weight basis, were combined in a muller. Sufficient water was added during the mixing process to produce an extrudable paste and the mixture was extruded into a 1/16″ cylinder and then dried in an oven at 121° C. overnight. The dried extrudate was calcined in nitrogen @ 538° C. to decompose and remove the organic template. The nitrogen calcined extrudate was humidified with saturated air and exchanged with 1 N ammonium nitrate to remove sodium. After ammonium nitrate exchange, the extrudate was washed with deionized water and dried at 121° C. overnight. The catalyst was then calcined in air at 538° C.

Catalyst 4: 80/20 ZSM-12/Alumina. 80/20 ZSM-12/Alumina. 80 parts of ZSM-12 crystal (45/1 Si/Al2) and 20 parts of pseudoboehmite alumina, on a calcined dry weight basis, were combined in a muller. Sufficient water was added during the mixing process to produce an extrudable paste and the mixture was extruded into a 1/16″ cylinder and then dried in an oven at 121° C. overnight. The dried extrudate was calcined in nitrogen @ 538° C. to decompose and remove the organic template. The nitrogen calcined extrudate was humidified with saturated air and exchanged with 1 N ammonium nitrate to remove sodium. After ammonium nitrate exchange, the extrudate was washed with deionized water and dried at 121° C. overnight. The catalyst was then calcined in air at 538° C.

Catalyst 5: 80/20 NH4-USY/Alumina. 80 parts of CBV-712 crystal (12/1 Si/Al2) and 20 parts of pseudoboehmite alumina, on a calcined dry weight basis, were combined in a muller. Sufficient water was added during the mixing process to produce an extrudable paste and the mixture was extruded into a 1/16″ cylinder and then dried in an oven at 121° C. overnight.

Catalyst 6. 80/20 EMM-57/Alumina 80 parts of EMM-57 crystal (78/1 Si/Al2) and 20 parts of pseudoboehmite alumina, on a calcined dry weight basis, were combined in a muller. Sufficient water was added during mixing to produce an extrudable paste and the mixture was extruded into a 1/16″ cylinder and then dried in an oven at 121° C. overnight. The dried extrudate was calcined in nitrogen @ 538° C. to decompose and remove the organic template. The nitrogen calcined extrudate was humidified with saturated air and exchanged with 1 N ammonium nitrate to remove sodium. After ammonium nitrate exchange, the extrudate was washed with deionized water and dried at 121° C. overnight. The catalyst was then calcined in air at 538° C.

Catalyst 7: 80/20 MCM-49/Alumina. 80 parts of MCM-49 crystal (20/1 Si/Al2), and 20 parts of pseudoboehmite alumina, on a calcined dry weight basis, were combined in a muller. Sufficient water was added during mixing to produce an extrudable paste and the mixture was extruded into a 1/16″ cylinder and then dried in an oven at 121° C. overnight. The dried extrudate exchanged with 1 N ammonium nitrate to remove sodium. After ammonium nitrate exchange, the extrudate was washed with deionized water and dried at 121° C. overnight. The dried extrudate was then heated in nitrogen to 538° C. and held for 3 hours. The temperature was decreased to 410 C in nitrogen and then nitrogen was slowly decreased while oxygen was slowly increased to 21% while heating to 530 C. The catalyst was held at 530 C and 21% 02 for 9 hours.

Catalyst 8: 95/5 MCM-49/Silica 95/5 MCM-49/Silica. 95 parts of MCM-49 crystal (20/1 Si/Al2) and 5 parts of silica (precipitated/colloidal silica), on a calcined dry weight basis were combined in a muller. Sufficient water was added during the mixing process to produce an extrudable paste and the mixture was extruded into a 1/16″ cylinder and then dried in an oven at 121° C. overnight. The dried extrudate exchanged with 1 N ammonium nitrate to remove sodium. After ammonium nitrate exchange, the extrudate was washed with deionized water and dried at 121° C. overnight. The dried extrudate was then heated in nitrogen to 538° C. and held for 3 hours. The temperature was decreased to 410° C. in nitrogen and then nitrogen was slowly decreased while oxygen was slowly increased to 21% while heating to 530° C. The catalyst was held at 530° C. and 21% O2 for 9 hours.

Catalyst 9: 80/20 EMM-34/Alumina. 80 parts of EMM-34 crystal (21/1 Si/Al2) and 20 parts of pseudoboehmite alumina, on a calcined dry weight basis, were combined in a muller. Sufficient water was added during the mixing process, to produce an extrudable paste and the mixture was extruded into a 1/16″ cylinder and then dried in an oven at 121° C. overnight. The dried extrudate was calcined in nitrogen @ 538° C. to decompose and remove the organic template. The nitrogen calcined extrudate was humidified with saturated air and exchanged with 1 N ammonium nitrate to remove sodium. After ammonium nitrate exchange, the extrudate was washed with deionized water and dried at 121° C. overnight. The catalyst was then calcined in air at 538° C.

Catalyst 10: 80/20 USC-Beta/Alumina. 80 parts of USC-Beta crystal (28/1 Si/Al2) and 20 parts of pseudoboehmite alumina, on a calcined dry weight basis, were combined in a muller. Sufficient water was added to during the mixing process to produce an extrudable paste and the mixture was extruded into a 1/16″ cylinder and then dried in an oven at 121° C. overnight. The dried extrudate was calcined in nitrogen @ 538° C. to decompose and remove the organic template. The nitrogen calcined extrudate was humidified with saturated air and exchanged with 1 N ammonium nitrate to remove sodium. After ammonium nitrate exchange, the extrudate was washed with deionized water and dried at 121° C. overnight. The catalyst was then calcined in air at 538° C.

Catalyst 11: 65/35 ITQ-39/Alumina. 65 parts of ITQ-39 crystal (38/1 Si/Al2) and 35 parts of alumina, on a calcined dry weight basis, were combined in a muller. Sufficient water was added during mixing to produce an extrudable paste and the mixture was extruded into a 1/16″ cylinder and then dried in an oven at 121° C. overnight. The dried extrudate exchanged with 1 N ammonium nitrate to remove sodium. After ammonium nitrate exchange, the extrudate was washed with deionized water and dried at 121° C. overnight. The catalyst was then calcined in air at 538° C.

Catalyst 12: 65/35 EMM-23/Alumina. 65 parts of EMM-23 crystal (150/1 Si/Al2) and 35 parts of alumina, on a calcined dry weight basis, were combined in a muller. Sufficient water was added during the mixing process to produce an extrudable paste and the mixture was extruded into a 1/16″ cylinder and then dried in an oven at 121° C. overnight. The dried extrudate exchanged with 1 N ammonium nitrate to remove sodium. After ammonium nitrate exchange, the extrudate was washed with deionized water and dried at 121° C. overnight. The catalyst was then calcined in air at 538° C.

Each of the above synthesized catalysts were characterized by Si/Al2 ratio, largest pore diameter, alpha, BET surface area, micropore surface area, and external surface area. The results of the characterization are shown in Table 1.

TABLE 1

| | | Largest Pore | | BET Total | Micropore | External |
|---|---|---|---|---|---|---|
| Catalyst | Si/Al2 | Diameter | Alpha | SA, m2/g | SA, m2/g | SA, m2/g |
| Catalyst 1 | 60 | 5.6 | 440 | 429 | 275 | 155 |
| Catalyst 2 | 54 | 5.6 | 97 | 584 | 120 | 464 |
| Catalyst 3 | 70 | 5.6 | 75 | 305 | 105 | 199 |
| Catalyst 4 | 45 | 6 | 580 | 299 | 180 | 119 |
| Catalyst 5 | 12 | 7.4 | 290 | 768 | 613 | 155 |
| Catalyst 6 | 78 | 8.2 | 92 | 437 | 252 | 185 |
| Catalyst 7 | 20 | 9.1 | 590 | 490 | 333 | 157 |
| Catalyst 8 | 20 | 9.1 | 690 | 577 | 453 | 124 |
| Catalyst 9 | 21 | 7.0 | 480 | 477 | 355 | 122 |
| Catalyst 10 | 20 | 9.1 | 690 | 577 | 453 | 124 |
| Catalyst 11 | 38 | 6.6 | 330 | 476 | 260 | 216 |
| Catalyst 12 | 150 | 10.8 | 68 | 690 | 437 | 253 |

### Example 6

In this Example, the catalysts synthesized in Example 5 were and utilized to synthesize jet range hydrocarbons from ethanol and tert-butyl alcohol using the test setup described above. The feed to the reactor was 76 wt. % ethanol and 24 wt. % tert-butyl alcohol. Typically, 2 grams of catalyst sized to 14×25 mesh was mixed with sand to a target 10 cc volume and loaded into the reactor. For the formulations with 65% zeolite, 2.46 grams were loaded to target consistent zeolite based WHSV as the formulations with 80% zeolite. Glass wool and sand were used to make sure the catalyst bed was in the isothermal part of the reactor. The reactor was installed in the furnace with the catalyst bed in the middle of the furnace at the pre-marked isothermal zone. The reactor was then pressure and leak tested, typically at 800 psig. The catalyst was dried in flowing nitrogen at 350 C for 4 hour, the temperature was decreased to 190° C. under nitrogen and the pressure increased to 750 psig. Nitrogen was shut off and feed was introduced at a rate of 4.05 cc/h. In general, 24 h MB were obtained with 2 GC shots per MB and each condition was held for 3 days. The total effluent was analyzed by an online GC. The GC uses a TCD detector and is not able to analyze water. CHO balances were used to calculate water yields. The online method used product lumping as the product mix was too complex to discretely identify each peak. It could effectively identify up through C6 and some C8 molecules. Unknowns were then bucketed as C8 or C12+. Therefore, data shown here is a high-level comparison between catalysts and C8 and C12+ buckets will contain other molecules. The screening protocol utilized is shown in Table 2.

TABLE 2

| | | | | |
|---|---|---|---|---|
| Pressure, psig, barg | 750 (51.7) | 750 (51.7) | 750 (51.7) | 750 (51.7) |
| Temp ° C. | 190 | 210 | 210 | 230 |
| WHSV | 1.6 | 1.6 | 3.2 | 3.2 |
| Feed Flow rate, cc/h | 4.05 | 4.05 | 8.1 | 8.1 |

Table 3 shows the results of the catalyst performance data at 190° C. and Table 4 shows data at 210° C. Results shown are the average of lined out GCs taken during that condition. The data clearly shows that multiple zeolites are able to directly convert ethanol with the use of an activator molecule to jet range molecules. It was observed that medium pore zeolites known to be effective for olefin oligomerization, such as MFI, were not as effective as larger pore zeolites at forming jet range hydrocarbons. It was further observed that increasing external surface area and external acid sites by moving to relatively smaller crystals such as MFI crystals in EMM-20 did show a slight improvement to molecular weight growth to C8s, but still not as effective as larger pore zeolites. It was observed that ZSM-12, a unidimensional 12-ring zeolite, showed the highest selectivity to C8 product but lower selectivity to C12+ product. It was observed that MCM-49 and EMM-57, a unidimensional 14-ring zeolite is most effective for heavier product formation (C12+ yield and selectivity). It was observed that some catalysts are very effective for dehydration of ethanol to diethylether and TBA to isobutylene but less effective for molecular weight growth. This is true in the case of ZSM-48, a unidimensional 10-ring zeolite.

A separate synthesis was performed with a 78 wt. % ethanol and 22 wt. % iso-butyl alcohol at 230° C. Table 5 shows the performance using iso-butyl alcohol as an activator molecule. It was observed that less effective iso-butyl alcohol as co-feed at higher temperature, MCM-49 was more effective for molecular weight growth than an ultra-small crystal beta (BEA) and a high activity mordenite (MOR).

TABLE 3

| | | WHSV | WHSV | Ethanol | TBA | C8 | C12+ | C8+ |
|---|---|---|---|---|---|---|---|---|
| | | (catalyst | (zeolite | Conversion | Conversion | Yield | yield | yield |
| Catalyst | Zeolite | basis) | basis) | % | % | wt. % | wt. % | wt. % |
| 1 | ZSM-5 | 1.6 | 2 | 19.4 | 60.9 | 2.8 | 0.1 | 2.9 |
| 2 | EMM-20 | 1.6 | 2 | 32.2 | 77.1 | 8.4 | 0.6 | 9 |
| 3 | ZSM-48 | 1.6 | 2 | 63.9 | 90 | 7.7 | 3.3 | 11 |
| 4 | ZSM-12 | 1.6 | 2 | 40.6 | 99.3 | 15.1 | 4.2 | 19.3 |
| 5 | USY | 1.6 | 2 | 26.7 | 96.6 | 11.5 | 6.9 | 18.4 |
| 6 | EMM-57 | 1.6 | 2 | 42.6 | 98.8 | 12 | 14.1 | 26.1 |
| 7 | MCM-49 | 1.6 | 2 | 57.9 | 99.9 | 8.9 | 26.8 | 35.7 |
| 8 | *95/5 | 1.6 | 1.7 | 63.6 | 99.9 | 9.7 | 23.3 | 33 |
| | MCM-49 | | | | | | | |
| 11 | *65/35 | 1.3 | 2 | 30.9 | 98.1 | 13.5 | 3.5 | 17 |
| | ITQ-39 | | | | | | | |
| 12 | *65/35 | 1.3 | 2 | 27.7 | 96.4 | 13.1 | 9.2 | 22.3 |
| | EMM-23 | | | | | | | |

| | water | | | | | | |
|---|---|---|---|---|---|---|---|
| | yield | | | | | | |
| Catalyst | wt. % | C8 | C12+ | Diethylether | Isobutylene | Propene | Isobutane |
| 1 | 7.3 | 13 | 0.4 | 32.9 | 39.4 | 0.56 | 5.6 |
| 2 | 10.4 | 25.9 | 1.7 | 40.9 | 15.8 | 0.79 | 6.7 |
| 3 | 16.4 | 14.3 | 6.2 | 57.9 | 5.9 | 0.13 | 9.3 |
| 4 | 15 | 38.1 | 10.6 | 23.2 | 0.4 | 0.03 | 6.1 |
| 5 | 11.5 | 36.2 | 21.5 | 24.8 | 6.7 | 0.03 | 3.5 |
| 6 | 16.3 | 30.2 | 35.4 | 17.2 | 1.4 | 0.92 | 6.5 |
| 7 | 21.2 | 19.2 | 57.4 | 12.5 | 0.05 | 0.04 | 4.6 |
| 8 | 21.4 | 19.1 | 45.9 | 23.5 | 0.04 | 0.26 | 4.9 |
| 11 | 12.2 | 38.9 | 10.1 | 25.4 | 1.2 | 1.3 | 10.9 |
| 12 | 12.2 | 41.3 | 28.8 | 17.4 | 2.4 | 0.045 | 4.7 |

TABLE 4

| | | WHSV | WHSV | Ethanol | Isobutyl | C8 | C12+ | C8+ |
|---|---|---|---|---|---|---|---|---|
| | | (catalyst | (zeolite | Conversion | Alcohol | Yield | yield | yield |
| Catalyst | Zeolite | basis) | basis) | % | Conversion % | wt. % | wt. % | wt. % |
| 1 | ZSM-5 | 1.6 | 2 | 41.1 | 85.3 | 5.9 | 0.5 | 6.4 |
| 2 | EMM-20 | 1.6 | 2 | 55.1 | 93.3 | 10.4 | 1.2 | 11.6 |
| 3 | ZSM-48 | 1.6 | 2 | 81 | 98.1 | 10.2 | 11.3 | 21.5 |
| 4 | ZSM-12 | 1.6 | 2 | 72 | 99.7 | 16.1 | 8.2 | 24.3 |
| 5 | USY | 1.6 | 2 | 39.8 | 96.1 | 11.9 | 7.7 | 19.7 |
| 6 | EMM-57 | 1.6 | 2 | 62.8 | 99.6 | 11.2 | 18.9 | 30.1 |
| 7 | MCM-49 | 1.6 | 2 | 70.8 | 99 | 8.6 | 25.9 | 34.5 |
| 11 | *65/35 | 1.3 | 2 | 40.8 | 98.4 | 12.5 | 5.3 | 17.8 |
| | ITQ-39 | | | | | | | |
| 12 | *65/35 | 1.3 | 2 | 31.8 | 95.7 | 14.4 | 7.1 | 21.5 |
| | EMM-23 | | | | | | | |

| | water | | | | | | |
|---|---|---|---|---|---|---|---|
| | yield | | | Diethyl | | | |
| Catalyst | wt. % | C8 | C12+ | ether | Isobutylene | Propene | Isobutane |
| 1 | 12.3 | 14.9 | 1.3 | 47.4 | 18 | 1.1 | 6.6 |
| 2 | 15.3 | 21.2 | 2.4 | 51.4 | 7.1 | 1.1 | 6.9 |
| 3 | 21.3 | 16 | 17.8 | 52.1 | 3.2 | 0.3 | 8.3 |
| 4 | 21.5 | 28.2 | 14.2 | 34.5 | 0.2 | 0.1 | 5.5 |
| 5 | 13.5 | 30.1 | 19.5 | 38.2 | 3.6 | 0.1 | 4.4 |
| 6 | 20.7 | 22.8 | 36.3 | 26.2 | 0.5 | 1 | 5.6 |
| 7 | 23.2 | 15.9 | 47.8 | 23.8 | 0 | 0.1 | 5.8 |
| 11 | 14.2 | 31.2 | 13.5 | 32.1 | 1.6 | 1.1 | 9.7 |
| 12 | 12.9 | 42.4 | 20.6 | 22.2 | 4.2 | 0.2 | 5.2 |

TABLE 5

| | | WHSV | WHSV | | Isobutyl | C8 | C12+ | C8+ |
|---|---|---|---|---|---|---|---|---|
| | | (catalyst | (zeolite | Ethanol | Alcohol | Yield | yield | yield |
| Catalyst | Zeolite | basis) | basis) | Conversion % | Conversion % | wt. % | wt. % | wt. % |
| 9 | EMM-34 | 1.6 | 2 | 52.2 | 53.1 | 1.6 | 3 | 4.6 |
| 10 | USC-Beta | 1.6 | 2 | 81.9 | 96.3 | 5 | 17 | 22 |
| 8 | MCM-49 | 1.6 | 2 | 89 | 99.1 | 5.2 | 33.2 | 38.5 |

| | water | | | | | | |
|---|---|---|---|---|---|---|---|
| | yield | | | Diethyl | | | |
| Catalyst | wt. % | C8 | C12+ | ether | 2-Butenes | Propene | Isobutane |
| 9 | 11.7 | 4.1 | 3.4 | 48.7 | 4.7 | 12.9 | 6.9 |
| 10 | 20.5 | 7.9 | 18.7 | 45.3 | 3.2 | 1.4 | 7 |
| 8 | 26.8 | 8.1 | 43.8 | 29.9 | 1.4 | 1.9 | 7.7 |

### Example 7

In this example, a simulated recycle feed was evaluated. The testing of the catalyst described in Example 1 was run with blend 75 wt % ethanol, 10 wt. % 2,4,4 Trimethyl-1-pentene (C8), 5 wt. % 4-methyl-1-pentene (C6), 5 wt. % 2-methyl-butane (C5), and 5 wt. % Diethyl ether at temperature 190° C. and pressure 750 psig. The outcome of the test was compared to a feed of 75 wt. % ethanol and 25 wt. % TBA. It was observed that the recycle feed was able to convert the alcohol to olefins. The data indicates that there is no need to continuously use the C4 activator, it is need one time to generate C6 and C8 olefins and then recycling these olefins will convert ethanol to jet range hydrocarbons. FIG. 12 is a bar graph showing the results of the experiment.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. A method comprising:
introducing a feed comprising an alcohol and an activator into a reactor comprising a solid acid catalyst; and
contacting the alcohol and the activator with the solid acid catalyst under conditions effective to convert at least a portion of the alcohol and the activator to produce a product stream comprising C₆-C₁₆ olefins.

2. The method of claim 1 wherein the alcohol has a carbon number in a range from C₁ to C₇.

3. The method of claim 1 wherein the alcohol comprises ethanol.

4. The method of claim 1 where in the activator comprises a C₃-C₁₆ alcohol and/or C₃-C₁₆ olefin.

5. The method of claim 1 wherein the activator comprises at least one activator selected from the group consisting of propylene, isopropyl alcohol, 1-propanol, n-butene, 2-butene, 1-butanol, 2-butanol, tert-butyl alcohol, iso-butyl alcohol, isobutylene, 4-methyl-1-pentene, 2,4,4, trimethyl-1-pentene, and combinations thereof.

6. The method of claim 1 wherein the alcohol and/or the activator contain at least 50 wt % biogenic carbon as measured by ASTM D6866.

7. The method of claim 1 wherein the activator comprises an olefin activator, wherein the olefin activator is separated from an effluent from a fluidized catalytic cracker unit, an effluent from a coker unit, an effluent from a cracking unit, or combinations thereof.

8. The method of claim 1 wherein the solid acid catalyst comprises silica-alumina materials with 8, 10, 11, and/or 12 membered rings.

9. The method of claim 1 wherein the solid acid catalyst comprises a framework selected from the group consisting of MWW, MFI, MRE*, MTW, DON, FAU, -ITN*, -EWT, BEA, MOR, DDR, FER, SZR, EUO, MTT, TON, MEL, MFS, IMF, MSE, MEI, IWV, EMT, MAZ, LTL, and combinations thereof.

10. The method of claim 1 wherein the solid acid catalyst comprise a zeolite selected form the group consisting of EMC-2, EMM-10, EMM-12, EMM-13, EMM-20, EMM-23, EMM-34, EMM-57, EMM-72, ERB-1, ITQ-1, ITQ-2, ITQ-27, ITQ-39, MCM-22, MCM-36, MCM-49, MCM-56, MCM-68, MIT-1, PSH-3, SUZ-4, SSZ-25, USY, H-form USY, NH4-USY, USC-Beta, UZM-8, UZM-8HS, UZM-37, ZSM-5, ZSM-11, ZSM-12, ZSM-18, ZSM-22, ZSM-23, ZSM-35, ZSM-48, ZSM-58, ZSM-50, ZSM-57, COK-5, Mazzite, Linde Type L, and combinations thereof.

11. The method of claim 1 wherein the solid acid catalyst comprises at least one solid acid catalyst selected from the group consisting of Cs_{2.5}PW₁₂O₄₀, H₃PW₁₂O₄₀, H₃PMo₁₂O₄₀, H₃PMo₆V₆O₄₀, H₅PMo₁₀V₂O₄₀, mixed metal oxides, including but not limited to mixed metal oxide that is at least partially crystalline and comprises tungsten, zirconium, and a variable oxidation state metal selected from the group consisting of Fe, Mn, Co, Cu, Ce, Ni and any combination thereof, and silica-alumina hydrates containing Brønsted-acidic sites, and combinations thereof.

12. The method of claim 1 wherein the feed further comprises water and/or wastewater containing an olefin activator.

13. The method of claim 1 further comprising separating a portion of the C₆-C₁₆ olefins from the product stream and introducing the portion of the C₆-C₁₆ olefins into the reactor as a recycle stream.

14. The method of claim 1 further comprising:
separating a recycle stream from the product stream, the recycle stream comprising unreacted alcohol;
introducing the recycle stream into a second reactor comprising a solid acid catalyst;
dehydrating at least a portion of the unreacted alcohol to form a corresponding ether in the second reactor; and
introducing at least a portion of the corresponding ether into the reactor comprising a solid acid catalyst.

15. The method of claim 1 wherein the activator is introduced into the reactor at two or more points along a length of the reactor.

16. The method of claim 1 wherein the product stream further comprises at least one compound selected from the group consisting of a C₃ to C₁₆ paraffin, C₃ to C₁₆ cycloparaffin, C₃ to C₁₆ dicycloparaffin, C₃ to C₁₆ tricycloparaffin, benzene, C₃ to C₁₆ tetracycloparaffin, tetralin and C₁₁ to C₁₆ derivatives and isomers thereof, indane and C₁₀ to C₁₆ derivatives and isomers thereof, dicyclic benzenes, indene and C₁₀ to C₁₆ derivatives and isomers thereof, naphthalene and C₁₁ to C₁₆ derivatives and isomers thereof, bi-phenyl and C₁₃ to C₁₆ derivatives and isomers thereof, fluorene and C₁₄ to C₁₆ derivatives and isomers thereof, C₃ to C₁₆ alcohols and derivatives and isomers thereof, C₃ to C₁₆ ethers and derivatives and isomers thereof, C₃ to C₁₆ aldehydes and derivatives and isomers thereof, C₃ to C₁₆ ketones and derivatives and isomers thereof, C₆ to C₁₆ cyclic ketones and derivatives and isomers thereof, furan and C₅ to C₁₆ derivatives and isomers thereof, phenol and C₇ to C₁₆ derivatives and isomers thereof, benzyl aldehyde, benzyl ketone, benzofuran and C₉ to C₁₆ derivatives and isomers thereof, naphthol, indenofuran and C₁₃ to C₁₆ derivatives and isomers thereof, dibenzofuran and C₁₃ to C₁₆ derivatives and isomers thereof, and combinations thereof.

17. A method comprising:
introducing a feed comprising ethanol and an activator comprising a C₃-C₁₆ alcohol and/or a C₃-C₁₆ olefin into a reactor;
contacting the alcohol and the activator with a solid acid catalyst to produce at least C₈-C₁₆ olefins; and
withdrawing a product stream from the reactor, the product stream comprising the C₈-C₁₆ olefins.

18. The method of claim 17 wherein the solid acid catalyst comprises silica-alumina materials with 8, 10, 11, and/or 12 membered rings.

19. The method of claim 16 wherein the solid acid catalyst comprises a framework selected from the group consisting of MWW, MFI, MRE*, MTW, DON, FAU, -ITN*, -EWT, BEA, MOR, DDR, FER, SZR, EUO, MTT, TON, MEL, MFS, IMF, MSE, MEI, IWV, EMT, MAZ, LTL, and combinations thereof.

20. The method of claim 17 wherein the solid acid catalyst comprise a zeolite selected form the group consisting of EMC-2, EMM-10, EMM-12, EMM-13, EMM-20, EMM-23, EMM-34, EMM-57, EMM-72, ERB-1, ITQ-1, ITQ-2, ITQ-27, ITQ-39, MCM-22, MCM-36, MCM-49, MCM-56, MCM-68, MIT-1, PSH-3, SUZ-4, SSZ-25, USY, H-form USY, NH4-USY, USC-Beta, UZM-8, UZM-8HS, UZM-37, ZSM-5, ZSM-11, ZSM-12, ZSM-18, ZSM-22, ZSM-23, ZSM-35, ZSM-48, ZSM-58, ZSM-50, ZSM-57, COK-5, Mazzite, Linde Type L, and combinations thereof, or wherein the solid acid catalyst comprises at least one solid acid catalyst selected from the group consisting of Cs_{2.5}PW₁₂O₄₀, H₃PW₁₂O₄₀, H₃PMo₁₂O₄₀, H₃PMo₆V₆O₄₀, H₅PMo₁₀V₂O₄₀, mixed metal oxides, including but not limited to mixed metal oxide that is at least partially crystalline and comprises tungsten, zirconium, and a variable oxidation state metal selected from the group consisting of Fe, Mn, Co, Cu, Ce, Ni and any combination thereof, and silica-alumina hydrates containing Brønsted-acidic sites, and combinations thereof.

21. A composition comprising:
C₆-C₁₆ dibranched olefins in an amount of at least 40 wt %;
diethyl ether;
water; and
ethanol.

22. The composition of claim 21 further comprising at least one compound selected from the group consisting of a C₃ to C₁₆ paraffin, C₃ to C₁₆ cycloparaffin, C₃ to C₁₆ dicycloparaffin, C₃ to C₁₆ tricycloparaffin, benzene, C₃ to C₁₆ tetracycloparaffin, tetralin and C₁₁ to C₁₆ derivatives and isomers thereof, indane and C₁₀ to C₁₆ derivatives and isomers thereof, dicyclic benzenes, indene and C₁₀ to C₁₆ derivatives and isomers thereof, naphthalene and C₁₁ to C₁₆ derivatives and isomers thereof, bi-phenyl and C₁₃ to C₁₆ derivatives and isomers thereof, fluorene and C₁₄ to C₁₆ derivatives and isomers thereof, C₃ to C₁₆ alcohols and derivatives and isomers thereof, C₃ to C₁₆ ethers and derivatives and isomers thereof, C₃ to C₁₆ aldehydes and derivatives and isomers thereof, C₃ to C₁₆ ketones and derivatives and isomers thereof, C₆ to C₁₆ cyclic ketones and derivatives and isomers thereof, furan and C₅ to C₁₆ derivatives and isomers thereof, phenol and C₇ to C₁₆ derivatives and isomers thereof, benzyl aldehyde, benzyl ketone, benzofuran and C₉ to C₁₆ derivatives and isomers thereof, naphthol, indenofuran and C₁₃ to C₁₆ derivatives and isomers thereof, dibenzofuran and C₁₃ to C₁₆ derivatives and isomers thereof, and combinations thereof.
